(19) United States
(12) Patent Application Publication
(10) Pub. No.: US 2026/0231046 A1
(43) Pub. Date: Aug. 6, 2026

(54) METHOD AND DEVICE FOR CONTROLLING TRANSMISSION POWER OF RADIO FREQUENCY REPEATER

(71) Applicant: ELECTRONICS AND TELECOMMUNICATIONS RESEARCH INSTITUTE, Daejeon (KR)

(72) Inventors: Hoon Dong NOH, Daejeon (KR); Moon Sik LEE, Daejeon (KR); Jae Woo PARK, Daejeon (KR); Jae Seung LEE, Daejeon (KR)

(21) Appl. No.: 19/146,345

(22) PCT Filed: Feb. 13, 2024
(86) PCT No.: PCT/KR2024/002006

§ 371 Date: Jul. 8, 2025

(30) Foreign Application Priority Data
Feb. 13, 2023 (KR) 10-2023-0018627

(51) Int. Cl. H04W 52/14; H04W 52/36

(52) U.S. Cl. CPC H04W 52/146; H04W 52/36

(57) ABSTRACT

A method for a radio frequency repeater, according to one embodiment of the present disclosure, may comprise the steps of: determining one or more repeater power levels of the radio frequency repeater on the basis of an environment for the communication settings between the radio frequency repeater and a base station; reporting, to the base station, repeater power level information corresponding to the determined repeater power levels; receiving, from the base station, uplink transmission power parameters through higher layer signaling; determining uplink transmission power for the base station on the basis of the repeater power level information and transmission power parameters; and performing uplink transmission with the determined uplink transmission power.

### TECHNICAL FIELD

The present disclosure relates to a wireless communication technique, and more particularly, to a technique for controlling a transmit power of a wireless repeater in a wireless communication system.

### BACKGROUND ART

In future mobile communications such as 5G New Radio (NR) and 6G, the introduction of network-controlled repeaters (NCR), which can be controlled by a base station, is actively being discussed to overcome the limitations of conventional radio frequency (RF) repeaters that simply amplify and forward received signals.

In addition to devices for amplifying and forwarding received signals, the NCR may include devices for receiving control signals from the base station and transmitting responses back to the base station. The additional devices in the NCR may include multiple power amplifiers (PAs) for supporting carrier aggregation (CA) or dual connectivity (DC) in different frequency bands, multiple transmission and reception point (multi-TRP) functionality, or various types of radio links between the base station, repeater, and terminal such as backhaul link, control link, and access link.

According to the current 5G NR standards, if a terminal has multiple PAs for some of the mentioned purposes, a method is provided to determine the maximum transmit power P_{CMAX} for each uplink cell, and the base station and terminal can use this method to indicate or determine the uplink transmit power.

However, the conventional method for determining the maximum transmit power P_{CMAX} for each uplink cell according to the current 5G NR standards only considers the link between the base station and the terminal. Therefore, it is challenging to directly apply the conventional method, which considers only the link between the base station and the terminal, to various types of radio links between the base station, repeater, and terminal, such as backhaul link, control link, and access link.

### DISCLOSURE

### Technical Problem

The present disclosure for resolving the above-described demand is directed to providing a method and an apparatus for increasing a radio network performance through a network-controlled repeater by offering methods of determining a maximum transmit power, P_{CMAX}, in uplink cells of the network-controlled repeater.

### Technical Solution

A method of a wireless repeater, according to the present disclosure for achieving the above-described objective, may comprise: determining at least one repeater power class of the wireless repeater, based on a communication configuration environment between the wireless repeater and a base station; reporting repeater power class information corresponding to the determined at least one repeater power class to the base station; receiving uplink transmit power parameters from the base station through higher layer signaling; determining an uplink transmit power for the base station based on the repeater power class information and the uplink transmit power parameters; and performing uplink transmission using the determined uplink transmit power.

The communication configuration environment may be determined based on at least one of the at least one repeater power class of the wireless repeater, a frequency band used by the wireless repeater, or a transmission bandwidth of the wireless repeater.

The at least one repeater power class may include at least one of a first power class applied to a backhaul link or a second power class applied to uplink transmission of a control link.

The first power class and the second power class may be simultaneously reported to the base station.

The method may further comprise: reporting at least one of the first power class or the second power class to the base station; and reporting an unreported remaining one of the first power class or the second power class to the base station.

The method may further comprise: calculating a power reduction value based on a transmit power change situation when a change condition of the uplink transmit power is satisfied; and in response to the power reduction value smaller than a threshold value based on the uplink transmit power parameters, updating the uplink transmit power using the power reduction value.

The method may further comprise: in response to the power reduction value equal to or greater than a threshold value based on the uplink transmit power parameters, dropping the uplink transmission.

The change condition may include at least one of a case when the wireless repeater performs uplink transmissions for different uplink cells based on dual connectivity (DC), a case when the wireless repeater performs different uplink transmissions based on carrier aggregation (CA) in different frequency bands, a case when uplink transmission of a backhaul link and uplink transmission of a control link are frequency-division-multiplexed (FDMed), or a case when uplink transmission of the backhaul link and uplink transmission of the control link are spatial-division-multiplexed (SDMed).

When the change condition is the case when uplink transmission of the backhaul link and uplink transmission of the control link are FDMed, the power reduction value may be calculated as a difference between a maximum available transmit power when the uplink transmission of the backhaul link is performed alone and a maximum transmit power when the uplink transmission of the backhaul link and the uplink transmission of the control link are simultaneously performed by frequency-division-multiplexing (FDM).

When the change condition is the case when uplink transmission of the backhaul link and uplink transmission of the control link are SDMed, the power reduction value may be calculated as a difference between a maximum available transmit power when the uplink transmission of the backhaul link is performed alone and a maximum transmit power when the uplink transmission of the backhaul link and the uplink transmission of the control link are simultaneously performed by spatial-division-multiplexing (SDM).

A method of a wireless repeater, according to an exemplary embodiment of the present disclosure, may comprise: determining at least one repeater power class of the wireless repeater, based on a communication configuration environment between the wireless repeater and a base station; reporting repeater power class information corresponding to the determined at least one repeater power class to the base station; receiving uplink transmit power parameters from the base station through higher layer signaling; in response to that a change condition of an uplink transmit power of a control link is satisfied, calculating a power reduction value based on a transmit power change situation, the uplink transmit power of the control link being determined based on the uplink transmit power parameters; and in response to the power reduction value less than a threshold value based on the uplink transmit power parameters, updating the uplink transmit power of the control link using the power reduction value.

The method may further comprise: in response to the power reduction value equal to or greater than a threshold value based on the uplink transmit power parameters, dropping uplink transmission on the control link.

The change condition may include at least one of a case when the wireless repeater performs uplink transmissions for different uplink cells based on dual connectivity (DC), a case when the wireless repeater performs different uplink transmissions based on carrier aggregation (CA) in different frequency bands, a case when uplink transmission of a backhaul link and uplink transmission of a control link are frequency-division-multiplexed (FDMed), or a case when uplink transmission of the backhaul link and uplink transmission of the control link are spatial-division-multiplexed (SDMed).

When the change condition is the case when uplink transmission of the backhaul link and uplink transmission of the control link are FDMed, the power reduction value may be calculated as a difference between a maximum available transmit power when the uplink transmission of the backhaul link is performed alone and a maximum transmit power when the uplink transmission of the backhaul link and the uplink transmission of the control link are simultaneously performed by frequency-division-multiplexing (FDM).

When the change condition is the case when uplink transmission of the backhaul link and uplink transmission of the control link are SDMed, the power reduction value may be calculated as a difference between a maximum available transmit power when the uplink transmission of the backhaul link is performed alone and a maximum transmit power when the uplink transmission of the backhaul link and the uplink transmission of the control link are simultaneously performed by spatial-division-multiplexing (SDM).

A wireless repeater, according to an exemplary embodiment of the present disclosure, may comprise a processor, and the processor may cause the wireless repeater to perform:
determining at least one repeater power class of the wireless repeater, based on a communication configuration environment between the wireless repeater and a base station; reporting repeater power class information corresponding to the determined at least one repeater power class to the base station; receiving uplink transmit power parameters from the base station through higher layer signaling; determining an uplink transmit power for the base station based on the repeater power class information and the uplink transmit power parameters; and performing uplink transmission using the determined uplink transmit power.

The communication configuration environment may be determined based on at least one of the at least one repeater power class of the wireless repeater, a frequency band used by the wireless repeater, or a transmission bandwidth of the wireless repeater, and the at least one repeater power class may include at least one of a first power class applied to a backhaul link or a second power class applied to uplink transmission of a control link.

The processor may further cause the wireless repeater to perform:
simultaneously reporting the first power class and the second power class to the base station; or reporting at least one of the first power class or the second power class to the base station and reporting an unreported remaining one of the first power class or the second power class to the base station.

The processor may further cause the wireless repeater to perform:
calculating a power reduction value based on a transmit power change situation when a change condition of the uplink transmit power is satisfied; in response to the power reduction value smaller than a threshold value based on the uplink transmit power parameters, updating the uplink transmit power using the power reduction value; and in response to the power reduction value equal to or greater than a threshold value based on the uplink transmit power parameters, dropping the uplink transmission.

The change condition may include at least one of a case when the wireless repeater performs uplink transmissions for different uplink cells based on dual connectivity (DC), a case when the wireless repeater performs different uplink transmissions based on carrier aggregation (CA) in different frequency bands, a case when uplink transmission of a backhaul link and uplink transmission of a control link are frequency-division-multiplexed (FDMed), or a case when uplink transmission of the backhaul link and uplink transmission of the control link are spatial-division-multiplexed (SDMed).

### Advantageous Effects

The exemplary embodiments of the present disclosure provide methods for controlling and determining an uplink transmit power of a repeater. Through this, a wireless repeater according to the present disclosure can efficiently perform amplification and forwarding of its own uplink transmission signals and a terminal's signals. Therefore, by applying the method and apparatus according to the present disclosure, the performance gain of the wireless network through the network-controlled repeater can be increased.

### DESCRIPTION OF DRAWINGS

FIG. 1 is a conceptual diagram illustrating an exemplary embodiment of a radio interface protocol structure in a communication system.

FIG. 2 is a conceptual diagram illustrating an exemplary embodiment of time resources in which radio signals are transmitted in a communication system.

FIG. 3 is a conceptual diagram illustrating a time difference between a reception timing of an i-th downlink frame and a transmission timing of an i-th uplink frame in an exemplary embodiment of a communication system.

FIG. 4 is a conceptual diagram illustrating an exemplary embodiment of a time/frequency resource grid of a communication system.

FIG. 5 is a conceptual diagram illustrating an exemplary embodiment of a synchronization signal and physical broadcast channel (SS/PBCH) block of a communication system.

FIG. 6 is a sequence chart illustrating an exemplary embodiment of a random access procedure in a communication system.

FIG. 7 is a conceptual diagram illustrating a first exemplary embodiment of SSB-RO association according to RACH configuration in a communication system.

FIG. 8 is a conceptual diagram illustrating a second exemplary embodiment of SSB-RO association according to RACH configuration in a communication system.

FIG. 9 is a conceptual diagram illustrating an exemplary embodiment of a QCL information transfer process through TCI state configuration and indication in a communication system.

FIG. 10 is a conceptual diagram illustrating an exemplary embodiment of a TCI state activation/deactivation MAC CE in a communication system.

FIG. 11 is a conceptual diagram illustrating an exemplary embodiment of a TCI state indication MAC CE in a communication system.

FIG. 12 is a conceptual diagram illustrating slot configurations according to slot formats in a communication system.

FIG. 13 is a sequence chart illustrating an exemplary embodiment of a UE capability reporting procedure in a communication system.

FIGS. 14A and 14B are conceptual diagrams for describing a first exemplary embodiment of a user plane protocol stack structure and a control plane protocol stack structure in a communication system.

FIG. 15 is a conceptual diagram illustrating an example of network configuration through IAB features.

FIG. 16 is a conceptual diagram illustrating deployment of a commercial RF repeater.

FIG. 17 is a conceptual diagram illustrating a protocol stack for a control plane and a user plane of a wireless communication system including an RF repeater.

FIG. 18 is a conceptual diagram illustrating a protocol stack for a control plane of an advanced repeater according to an exemplary embodiment of the present disclosure.

FIG. 19 is a conceptual diagram for describing cell-specific configuration, terminal-specific configuration, and indication information within a specific given time according to TDD configuration.

FIG. 20 is a conceptual diagram for describing deployment of a network control repeater.

FIG. 21 is a conceptual diagram for describing an amplifier structure and an RF chain configuration according thereto in the NCR.

FIG. 22 is a conceptual diagram for describing an amplifier structure and another RF chain configuration according thereto in the NCR.

FIG. 23 is a conceptual diagram for describing an amplifier structure and yet another RF chain configuration according thereto in the NCR.

FIG. 24 is a conceptual diagram for describing an amplifier structure and yet another RF chain configuration according thereto in the NCR.

FIG. 25 is a flowchart for describing a case where a repeater needs to adjust an uplink transmit power in a specific cell during NR DC operations according to an exemplary embodiment of the present disclosure.

FIG. 26 is a flowchart for describing a case where a repeater needs to adjust an uplink transmit power in a specific cell during EN DC or NE DC operations according to an exemplary embodiment of the present disclosure.

FIG. 27 is a flowchart for describing a case where a repeater needs to adjust a specific uplink transmit power due to sharing some PAs between backhaul link uplink transmission and control link uplink transmission according to an exemplary embodiment of the present disclosure.

FIG. 28 is a flowchart for describing a case where a repeater needs to adjust a specific uplink transmit power when sharing some PAs between backhaul link uplink transmission and control link uplink transmission according to an exemplary embodiment of the present disclosure.

FIG. 29 is a block diagram illustrating a base station according to an exemplary embodiment of the present disclosure.

FIG. 30 is a block diagram illustrating a repeater according to an exemplary embodiment of the present disclosure.

### MODE FOR INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

In the present disclosure, “(re)transmission” may refer to “transmission”, “retransmission”, or “transmission and retransmission”, “(re)configuration” may refer to “configuration”, “reconfiguration”, or “configuration and reconfiguration”, “(re)connection” may refer to “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

A communication network to which exemplary embodiments according to the present disclosure are applied will be described. The communication network to which the exemplary embodiments according to the present disclosure are applied is not limited to the contents described below, and the exemplary embodiments according to the present disclosure may be applied to various communication networks. Here, the communication network may have the same meaning as a communication system. A communication network may refer to a wireless communication network, and a communication system may refer to a wireless communication system.

In the present disclosure, “configuration of an operation (e.g. transmission operation)” may refer to signaling of “control information (e.g. information element, parameter) for the operation” and/or “information indicating to perform the operation”. “An information element (e.g. parameter) is configured” may mean that the corresponding information element is signaled. In the present disclosure, signaling may be at least one of system information (SI) signaling (e.g. transmission of a system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multi-hop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

In particular, the present disclosure described below provides methods and apparatuses of controlling a transmit power for a network-controller repeater (NCR). The term ‘network repeater’ is used for convenience of description, and in actual applications, it may be referred to by various terms such as ‘smart repeater’, ‘smart relay’, ‘controllable repeater’, or the like.

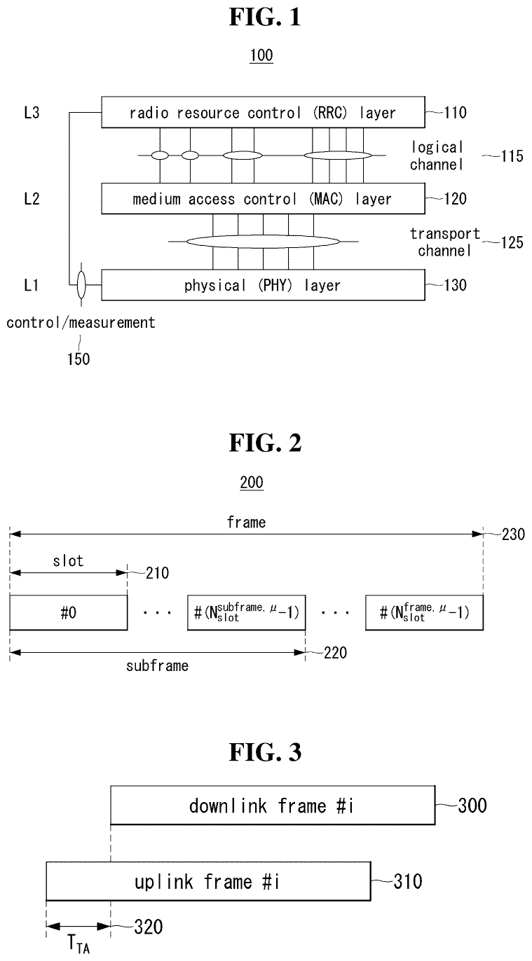

FIG. 1 is a conceptual diagram illustrating an exemplary embodiment of a radio interface protocol structure in a communication system.

Referring to FIG. 1, an exemplary embodiment of a radio interface protocol structure 100 of a communication system may be configured to include a radio resource control (RRC) layer 110, a medium access control (MAC) layer 120, a physical (PHY) layer 130, and the like. An exemplary embodiment of the radio interface protocol structure 100 shown in FIG. 1 may correspond to various exemplary embodiments of interfaces such as an interface between a terminal and a base station, an interface between an IAB-node distributed unit (IAB-DU) and an IAB-node mobile terminal (IAB-MT) of an integrated access backhaul (IAB) network, an interface between an IAB-DU and a lower node, an interface between an IAB-MT and an upper node, an interface between a plurality of terminals, and the like.

In the vicinity of the PHY layer 130, the RRC layer 110, and the MAC layer 120, and the like may be disposed above the PHY layer 130. For example, the MAC layer 120 may be disposed above the PHY layer 130. The RRC layer 110 may be disposed above the MAC layer 120.

The MAC layer 120 may be connected to a higher layer (e.g. RRC layer 110) through logical channels 115. The PHY layer 130 may be connected to the higher MAC layer 120 through transport channels 125. The PHY layer 130 may transmit and receive control information or measurement information 150 to and from the RRC layer 110.

The PHY layer 130 may be referred to as a ‘layer 1’ or ‘L1’. The MAC layer 120 may be referred to as a ‘layer 2’ or ‘L2’. The RRC layer 110 may be referred to as a ‘layer 3’ or ‘L3’. The RRC layer 110 and the MAC layer 120 may be collectively referred to as the ‘higher layer’.

In the present disclosure, ‘L1 signaling’ refers to signaling such as downlink control information (DCI) transmitted on a physical downlink control channel (PDCCH), uplink control information (UCI) transmitted on a physical uplink control channel (PUCCH), and sidelink control information (SCI) transmitted on a physical sidelink control channel (PSCCH), which are channels of the PHY layer 130. Similarly, in the present disclosure, ‘higher layer signaling’ may include L2 signaling transmitted through a MAC control element (CE), L3 signaling transmitted through RRC signaling, and the like.

In particular, for convenience of description, although omitted in FIG. 1 of the present disclosure, information that may be included in interfaces (e.g. F1, NG interfaces, etc.) between base stations or between base station components such as distributed units (DU) and central units (CU) may also be collectively referred to as higher layer signaling together with L2 signaling or L3 signaling.

In a communication system to which the 5G communication technology, etc. is applied, one or more of numerologies of Table 1 may be used in accordance with various purposes, such as inter-carrier interference (ICI) reduction according to frequency band characteristics, latency reduction according to service characteristics, and the like.

TABLE 1

| | Δf = 2^{μ} · 15 | |
|---|---|---|
| μ | [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

Table 1 is merely an example for the convenience of description, and exemplary embodiments of the numerologies used in the communication system may not be limited thereto. Each numerology μ may correspond to information of a subcarrier spacing (SCS) Δf and a cyclic prefix (CP). The terminal may identify a numerology y and a CP value applied to a downlink bandwidth part (BWP) or an uplink BWP based on higher layer parameters such as subcarrierSpacing, cyclicPrefix, and/or the like.

FIG. 2 is a conceptual diagram illustrating an exemplary embodiment of time resources in which radio signals are transmitted in a communication system.

Referring to FIG. 2, time resources in which radio signals are transmitted in a communication system 200 may be represented with a frame 220 comprising one or more

$$( {N}_{slot}^{frame , μ} / {N}_{slot}^{subframe , μ} )$$

subframes, a subframe 220 comprising one or more

$$( {N}_{slot}^{subframe , μ} )$$

slots, and a slot 210 comprising 14

$$( {N}_{symb}^{slot} )$$

OFDM symbols. In this case, according to a configured numerology, as the values of

$${N}_{symb}^{slot} , {N}_{slot}^{subframe , μ} , and {N}_{slot}^{frame , μ} ,$$

values according to Table 2 below may be used in case of a normal CP, and values according to Table 3 below may be used in case of an extended CP. The OFDM symbols included within one slot may be classified into ‘downlink’, ‘flexible’, or ‘uplink’ by higher layer signaling or a combination of higher layer signaling and L1 signaling.

TABLE 2

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 3

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

In the 5G NR communication system, the frame 230 may have a length of 10 ms, and the subframe 220 may have a length of 1 ms. Each frame 230 may be divided into two half-frames having the same length, and the first half-frame (i.e. half-frame 0) may be composed of subframes #0 to #4, and the second half-frame (i.e. half-frame 1) may be composed of subframes #5 to #9. One carrier may include a set of frames for uplink (i.e. uplink frames) and a set of frames for downlink (i.e. downlink frames).

FIG. 3 is a conceptual diagram illustrating a time difference between a reception timing of an i-th downlink frame and a transmission timing of an i-th uplink frame in an exemplary embodiment of a communication system.

Referring to FIG. 3, a time difference between a reception timing of an i-th downlink frame 300 and a transmission timing of an i-th uplink frame 310 may be a TTA 320. Accordingly, the terminal may start transmission of the uplink frame #i 310 at a time earlier by TTA compared to the reception timing of the downlink frame #i 300. TTA may be referred to as a timing advance or timing adjustment TA. The base station may instruct the terminal to change a value of TTA through higher layer signaling or L1 signaling, and may configure the terminal to apply TTA in a manner defined as T_{TA}=(N_{TA}+N_{TA,offset})T_{c}. In the case of 5G NR, T_{c} may be defined as

$${T}_{c} = \frac{1}{( Δ {f}_{max} \cdot {N}_{f} )} , Δ {f}_{max}$$

may be defined as Δfₘₐₓ=480 kHz, N_{f} may be defined as N_{f}=4096, N_{TA,offset} may be a value set by L3 signaling, and N_{TA} may be a value determined by Equation 1 below by a value T_{A} indicated by L2 signaling.

$${N}_{TA} = \{ \begin{matrix}{T}_{A} \cdot 16 \cdot \frac{64}{{2}^{μ}} ( for random access response ) \\ {N}_{TA \_ old} + ( ( {T}_{A} - 31 ) \cdot 16 \cdot 64 / {2}^{μ} ) ( for other cases )\end{matrix} \qquad [ Equation 1 ]$$

Here, the description on N_{TA,offset} and N_{TA} may be an example for a specific situation, and various other options may exist, but in order not to obscure the gist of the description, all possible cases may not be listed in the present disclosure.

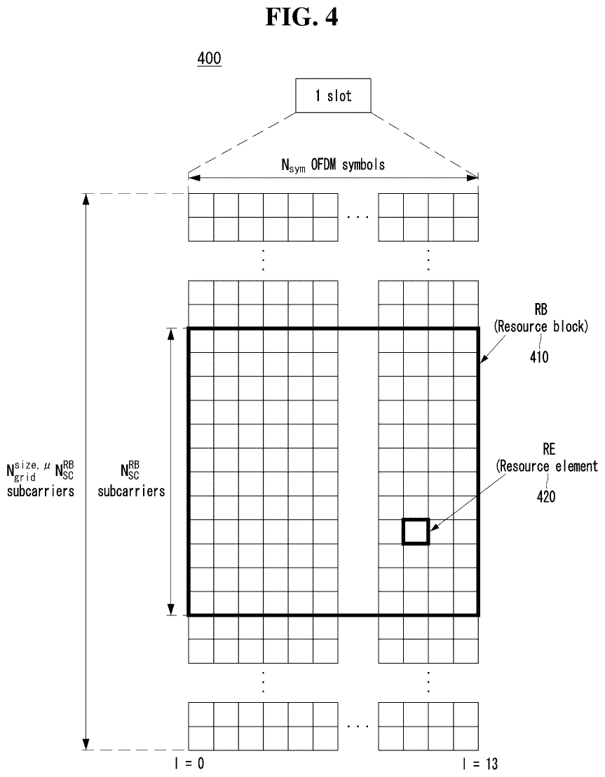

FIG. 4 is a conceptual diagram illustrating an exemplary embodiment of a time/frequency resource grid of a communication system.

Referring to FIG. 4, a time/frequency resource grid 400 of a communication system may have

$${N}_{grid}^{size , μ} {N}_{sc}^{RB}$$

subcarriers and

$${N}_{slot}^{subframe , μ} OFDMs .$$

The resource grid may be defined for each numerology and each carrier. In this case,

$${N}_{g r i d}^{start , μ}$$

may mean a position of a common resource block (CRB) indicated by higher layer signaling.

$${N}_{g r i d}^{size , μ}$$

may mean the number of resource blocks (RBs) starting from the CRB, that is, a carrier bandwidth.

$${N}_{g r i d}^{start , μ} and / or {N}_{g r i d}^{size , μ}$$

may have different values for each link direction (e.g. uplink, downlink, or sidelink) or for each numerology μ. Here, the numerology may be referred to by other terms, such as a SCS configuration, if necessary.

Each element in the resource grid for an antenna port p and a SCS configuration μ may be referred to as a resource element (RE) 420, and may be uniquely defined for each position (k, l)_{p,μ}. In this case, k may be a frequency axis index, and l may indicate a symbol position on the time axis. RE(k, l)_{p,μ} may correspond to a physical resource used to transmit a physical channel or a signal complex value

$${a}_{k , l}^{( p , μ )} .$$

One RB 410 may be defined as consecutive

$${N}_{s c}^{R B} = 12$$

subcarriers on the frequency axis.

The 5G NR communication system has introduced the concept of BWPs in order to reduce high implementation complexity and power consumption of terminals due to the widened carrier bandwidth compared to the 3G/4G communication system. One BWP may be composed of contiguous CRBs, a starting RB position

$${N}_{B WP , i}^{start , μ}$$

of the BWP and the number

$${N}_{BWP , i}^{s ize , μ}$$

of RBs constituting the BWP may satisfy Equations 2 and 3.

$${N}_{grid , x}^{s t art , μ} \leq {N}_{B WP , i}^{s t a r t , μ} < {N}_{grid , x}^{s t art , μ} + {N}_{g r i d , x}^{size , μ} \qquad [ Equation 2 ]$$

$${N}_{grid , x}^{s t art , μ} < {N}_{B WP , i}^{s t a r t , μ} + {N}_{B WP , i}^{s ize , μ} \leq {N}_{grid , x}^{s t art , μ} + {N}_{g rid , x}^{s i z e , μ} \qquad [ Equation 3 ]$$

Up to four downlink BWPs within one component carrier (CC) may be configured for one terminal, and only one downlink BWP may be activated at a time. The terminal may not receive a physical downlink shared channel (PDSCH), a physical downlink control channel (PDCCH), a channel state information reference signal (CSI-RS), or the like outside the activated BWP.

Up to four uplink BWPs within one CC may be configured for one terminal, and only one uplink BWP may be activated at a time. The terminal may not transmit a physical uplink shared channel (PUSCH), a physical uplink control channel (PUCCH), a sounding reference signal (SRS), or the like outside the activated BWP.

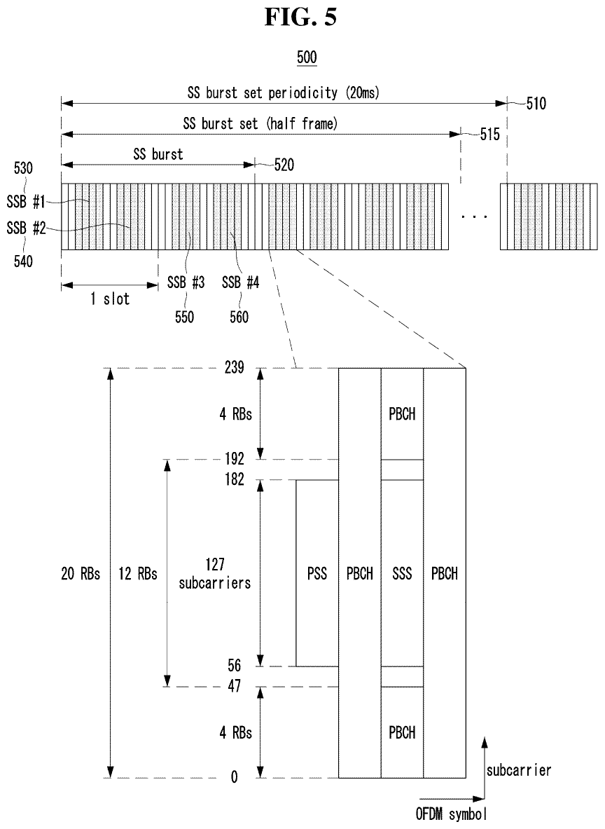

FIG. 5 is a conceptual diagram illustrating an exemplary embodiment of a synchronization signal and physical broadcast channel (SS/PBCH) block of a communication system.

Referring to FIG. 5, an SS/PBCH block 500 of a communication system may be configured with a primary synchronization signal (PSS) transmitted in 127 subcarriers in the middle of a first OFDM symbol, a secondary synchronization signal (SSS) transmitted in 127 subcarriers in the middle of a third OFDM symbol, and a physical broadcast channel (PBCH) transmitted in second, third, and fourth OFDM symbols. The PBCH occupying the widest bandwidth may be transmitted over 20 RBs, which may be 3.6 MHz based on 15 kHz SCS. The base station transmits one SSB by applying the same beam. When the number of base station antennas increases or it is necessary to operate multiple beams such as applying one or more analog beams for high frequency support, the base station may support a multi-beam operation by transmitting multiple SSBs. Here, the term ‘beam’ may be expressed in various terms such as a transmission precoding or a spatial transmission (TX) filter when applied in practice. However, in order not to obscure the gist of the description, ‘beam’ is used hereinafter as a unified term.

For example, the base station may transmit a plurality of SSBs 530, 540, 550, and 560 to represent a plurality of beams (e.g. beam #1, beam #2, beam #3, beam #4). In this case, it may be possible that one or more SSBs are transmitted within one slot according to a pattern predetermined according to each numerology. The SSBs 530, 540, 550, and 560 to which different beams are applied may be bundled into one set by being included in an SS burst 520. The terminal may assume a half-frame window having a length of 5 ms at the time of monitoring SSBs. An SS burst set 515 configured by higher layer signaling within a half-frame may include one or more SS bursts 520. If RRC configuration values are unknown or unavailable when performing initial access (IA), the terminal may receive or measure the SSBs assuming that a periodicity of the SS burst set 510 is 20 ms. As an example, the terminal may receive SSB(s) with reference to SSB configuration information identical or similar to that shown in Table 4 and Table 5.

TABLE 4

| | |
|---|---|
| MIB ::= | SEQUENCE { |
| systemFrameNumber | |
| subCarrierSpacingCommon | |
| ssb-SubcarrierOffset | // SSB subcarrier offset (0~15) |
| dmrs-TypeA-Position | |
| pdcch-ConfigSIB1 | |
| cellBarred | |
| intraFreqReselection | |
| spare | |
| } | |
| MeasObjectNR ::= | SEQUENCE { |
| ssbFrequency | // Absolute Radio Frequency Channel Number (ARFCN) |
| of SSB | |
| ssbSubcarrierSpacing | // Numerology of SSB |
| smtc 1 | |

// first SSB measurement timing configuration (SMTC) configured with

reference to SSB-MTC

smtc2 // Second SMTC configured with reference to SSB-MTC

| | |
|---|---|
| ... | |
| ... | |
| } | |
| SSB-Index | // SSB index within SS-burst |

TABLE 5

| | |
|---|---|
| SSB-MTC ::= | SEQUENCE { |

// timing occasion configuration for SSBs to be measured by terminal

| | |
|---|---|
| periodicityAndOffset | CHOICE { |

```
    sf5  // offset when a SSB reception window has a legnth of 5 subframes
    sf10  // offset when a SSB reception window has a legnth of 10 subframes
    sf20  // offset when a SSB reception window has a legnth of 20 subframes
    sf40  // offset when a SSB reception window has a legnth of 40 subframes
    sf80  // offset when a SSB reception window has a legnth of 80 subframes
  sf160  // offset when a SSB reception window has a legnth of 160 subframes
  },
  duration  // a lengh of a SSB recepion window (number of subframes)
```

| | |
|---|---|
| } | |
| SSB-MTC2 ::= | SEQUENCE { |

```
  pci-List  // physical cell IDs (PCIs) following the SMTC configuration
  periodicity  // SMTC periodicity (number of subframes)
```

}

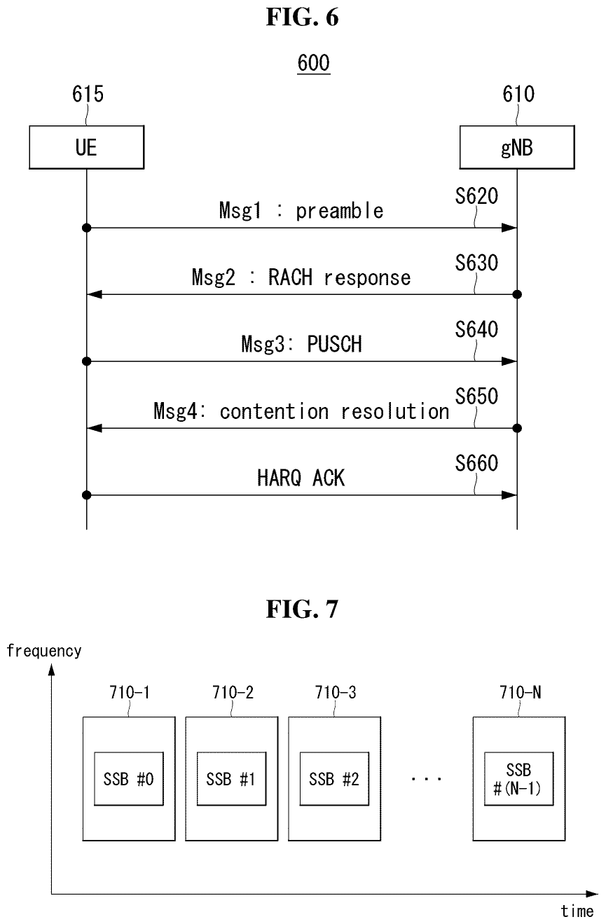

FIG. 6 is a sequence chart illustrating an exemplary embodiment of a random access procedure in a communication system.

Referring to FIG. 6, in a random access procedure of a communication system 600, a terminal 615 may transmit a physical random access channel (PRACH) preamble, and the PRACH preamble may be referred to as ‘Msg1’ (S620). Through a transmission of the PRACH preamble, random access-radio network temporary identifier (RA-RNTI) may be determined. In this case, the RA-RNTI may be calculated by Equation 4.

$$RA - RNTI = 1 + {s}_{id} + 14 \times {t}_{id} + 14 \times 80 \times {f}_{id} + 14 \times 80 \times 8 \times u {l}_{c a r r i e {r}_{i d}} \qquad [ Equation 4 ]$$

In Equation 4, s_{id} may be an index of a first OFDM symbol of a corresponding PRACH occasion (e.g. 0≤s_{id}<14), t_{id} may be an index of a first slot of the PRACH occasion within a system frame (e.g. 0≤t_{id}<80), f_{id} may be an index of the PRACH occasion in the time domain (e.g. 0≤f_{id}<8), and ul_{carrier}_{_{id}} may be a value according to a uplink carrier type used for the preamble transmission (e.g. 0 indicates a regular uplink carrier, 1 indicates a supplementary uplink carrier).

In Equation 4, s_{id} may be an index of a first OFDM symbol of a corresponding PRACH occasion (e.g. 0≤s_{id}<14), t_{id} may be an index of a first slot of the PRACH occasion within a system frame (e.g. 0≤t_{id}<80), f_{id} may be an index of the PRACH occasion in the time domain (e.g. 0≤f_{id}<8), and ul_{carrier}_{_{id}} may be a value according to a uplink carrier type used for the preamble transmission (e.g. 0 indicates a regular uplink carrier, 1 indicates a supplementary uplink carrier).

Before the terminal transmits the PRACH preamble, the terminal may have at least part of the following information by receiving system information from the base station on a PBCH or receiving RRC signaling from the base station.
PRACH preamble format
Time/frequency resource information for RACH transmission
Index for a logical root sequence table
Cyclic shift NCS
Set type (unrestricted, restricted set A, restricted set B)

Referring again to FIG. 6, as a second procedure, the base station may provide a random access response (RAR) to the terminal, which may be referred to as ‘Msg2’ (S630). Particularly, the base station may calculate an RA-RNTI based on Equation 4 when the base station receives the PRACH preamble from the terminal in the step S620, and may transmit a DCI by using the RA-RNTI for scrambling. The terminal may monitor a PDCCH scrambled with the RA-RNTI in a period included in a RACH response window configured by the higher layer in a type 1 PDCCH common search space (CSS). The terminal may receive the PDCCH (or the DCI transmitted from the base station through the PDCCH), and may decode the PDCCH (or the DCI). If the terminal successfully decodes the PDCCH (or the DCI), the terminal may decode a PDSCH including the RAR transmitted from the base station in the step S630. If the terminal succeeds in decoding the RAR, the terminal may identify whether an RA preamble identifier (RAPID) in the RAR matches a RAPID pre-allocated to the terminal.

As a third procedure, the terminal may transmit a PUSCH to the base station, which may be referred to as ‘Msg3’ (S640). To this end, the terminal may determine whether to apply a transform precoding to transmission of the PUSCH (i.e. whether to apply discrete Fourier transform (DFT)-s-OFDM-based transmission or OFDM-based transmission) based on a higher layer parameter (e.g. msg3-transformPrecoding). Also, the terminal may determine a SCS to be used for transmission of the PUSCH according to a higher layer parameter (e.g. msg3-scs). In this case, the PUSCH of Msg3 may be transmitted through a serving cell to which the PRACH has been transmitted.

As a fourth procedure, the base station may transmit a contention resolution message to the terminal, which may be referred to as ‘Msg4’ (S650). The terminal may start a timer for receiving the contention resolution message, and may monitor a PDCCH scrambled with a temporary cell-RNTI (TC-RNTI) in the type 1 PDCCH CSS until the timer expires. If the terminal successfully decodes the PDCCH, the terminal may decode a corresponding PDSCH including a MAC CE, and set the TC-RNTI as a cell-RNTI (C-RNTI). After successfully decoding the Msg4, the terminal may report a hybrid automatic repeat request (HARQ) positive-acknowledgement (ACK) thereto to the base station, and may report whether the RACH procedure is successful to the base station (S660).

The RACH occasion (RO) may mean a time and frequency resource specified for reception of a RACH preamble, and the terminal may use the RO for PRACH transmission. As described above, in the 5G NR, multiple SSBs may be associated with different beams for the multi-beam operation, and the terminal may measure the multiple SSBs, and select an optimal SSB (i.e. optimal beam) based on one of various schemes such as a reference signal received power (RSRP), reference signal received quality (RSRQ), signal-to-noise ratio (SNR), signal-to-noise/interference ratio (SNIR), or the like. Thereafter, the terminal may determine a beam (i.e. TX spatial filter) to be used for PRACH transmission based on the beam (i.e. RX spatial filter) used when receiving the optimal SSB. In this case, a relationship between SSB(s) and RO(s) may be established for the purpose of allowing the base station or the network to know which SSB (i.e. beam) the terminal has selected. Through such the relationship, the base station may know the SSB (i.e. beam) selected by the terminal based on the RO in which the terminal has transmitted the PRACH. For example, the relationship between SSB(s) and RO(s) may be determined with reference to the higher layer configurations identical or similar to those shown in Table 6 and Table 7.

TABLE 6

```
RACH-ConfigCommon ::= SEQUENCE {
  rach-ConfigGeneric // set of RACH parameters
  totalNumberOfRA-Preambles // the total number of RACH preambles (1~63)
  ssb-perRACH-OccasionAndCB-PreamblesPerSSB CHOICE {
    oneEighth // The number of preambles per SSB when one SSB is associated with eight
ROs
    oneFourth // The number of preambles per SSB when one SSB is associated with four
ROs
    oneHalf  // The number of preambles per SSB when one SSB is associated with two
ROs
    one // The number of preambles per SSB when one SSB is associated with one RO
    two // The number of preambles per SSB when two SSBs are associated with one
RO
    four // The number of preambles per SSB when four SSBs are associated with one
RO
        eight // The number of preambles per SSB when eigth SSBs are associated with
one RO
        sixteen // The number of preambles per SSB when sixteen SSBs are associated
with one RO
}
  groupBconfigured SEQUENCE
    ra-Msg3 SizeGroupA // The size of a transport block fro contention-based RA of Group
A
    messagePowerOffsetGroupB // Threshold for preamble selection
    numberOfRA-PreamblesGroupA // The number of CB preambles per SSB of Group A
}
```

TABLE 7

```
  ra-ContentionResolutionTimer // Initial value of a contention resolution timer
  rsrp-ThresholdSSB // Threshold for selection of an SSB and an associated RACH
resource
  rsrp-ThresholdSSB-SUL // Threshold for selection of an SSB and an associated RACH
resource in SUL
  prach-RootSequenceIndex CHOICE { // RACH root sequence index
    1839
    1139
  },
  msg1-SubcarrierSpacing  // SCS for Msg1 transmission
  restrictedSetConfig // one of {unrestricted, restricted set A, restricted set B}
msg3-transformPrecoder // whether to apply transform precoding in transmisison of
Msg3
  ...
}
RACH-ConfigGeneric ::= SEQUENCE {
  prach-ConfigurationIndex // indicates a preamble format, etc.
  msg1-FDM // The number of ROs FDMed at a time
  msg1-FrequencyStart // frequnency-axis offset of the lowest RO with reference to PRB
0
zeroCorrelationZoneConfig // N-CS configuration
  preambleReceivedTargetPower // Target power level at a network receiving node
preambleTransMax
// The maximum number of RA preambe transmissions performed unitl declaration of an RA
failure
    powerRampingStep // Power ramping step
  ra-Response Window // Msg2 (RAR) window length (number of slots)
  ...,
}
```

FIG. 7 is a conceptual diagram illustrating a first exemplary embodiment of SSB-RO association according to RACH configuration in a communication system.

Referring to FIG. 7, in an SSB-RO mapping relation according to the RACH configurations, in a certain frequency band, N SSBs 710-1 to 710-n having time resources which are separated from each other may be mapped to ROs 720-1 to 720-n having time resources which are separated from each other on a one-to-one basis. For example, if a higher layer parameter msg1-FDM is set to 1 (i.e. msg1-FDM=one) and a higher layer parameter ssb-perRACH-OccasionAndCB-PreamblesPerSSB is set to 1 (e.g. ssb-perRACH-OccasionAndCB-PreamblesPerSSB=one), the N different SSBs 710-1 to 710-n may be mapped to the N different ROs 720-1 to 720-n on a one-to-one basis.

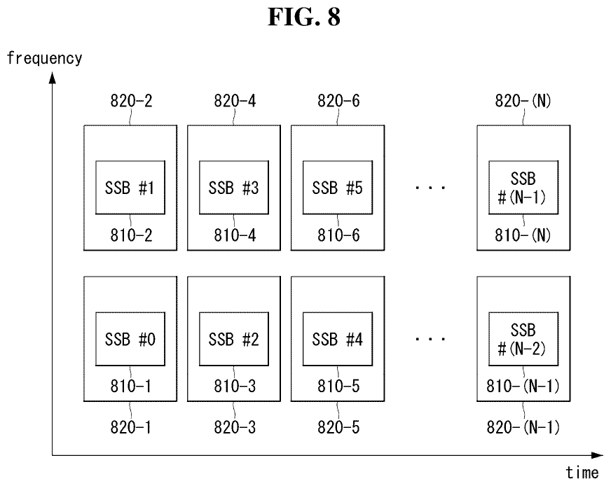

FIG. 8 is a conceptual diagram illustrating a second exemplary embodiment of SSB-RO association according to RACH configuration in a communication system.

Referring to FIG. 8, in an SSB-RO mapping relation according to the RACH configurations, in a first frequency band, SSBs 810-1, 810-3, 810-5, . . . , and 810-(n−1) having time resources which are separated from each other may be mapped to ROs 820-1, 820-3, 820-5, . . . , and 820-(n−1) having time resources which are separated from each other on a one-to-one basis. In addition, in a second frequency band, SSBs 810-2, 810-4, 810-6, . . . , and 810-n having time resources which are separated from each other may be mapped to ROs 820-2, 820-4, 820-6, . . . , and 820-n) having time resources which are separated from each other on a one-to-one basis. For example, if the higher layer parameter msg1-FDM is set to 2 (i.e. msg1-FDM=two), and higher layer parameter ssb-perRACH-OccasionAndCB-PreamblesPerSSB is set to 2 (e.g. ssb-perRACH-OccasionAndCB-PreamblesPerSSB=two), the N different SSBs 810-1 to 810-n may be mapped to the N different ROs 820-1 to 820-n which are frequency division multiplexed (FDMed) in a frequency domain, on a one-to-one basis.

Meanwhile, the 5G NR communication system may support DCI formats shown in Table 8 based on Release-16.

TABLE 8

| DCI | |
|---|---|
| format | Usage |
| 0_0 | Used for scheduling a PUSCH within one cell |
| 0_1 | Used for scheduling one or more PUSCHs within one cell, or indicating |
| | downlink feedback information for a configured grant (CG) PUSCH |
| | (i.e. CG-DFI) |
| 0_2 | Used for scheduling a PUSCH within one cell |
| 1_0 | Used for scheduling a PDSCH within one cell |
| 1_1 | Used for scheduling a PDSCH within one cell or triggering a one-shot |
| | HARQ-ACK codebook feedback |
| 1_2 | Used for scheduling a PDSCH within one cell |
| 2_0 | Used for notifying a slot format, an available RB set, a channel occupancy |
| | time (COT) duration, and search space set group switching to a UE group |
| 2_1 | Used for notifying PRB(s) and OFDM symbol(s) assumed not to be intended |
| | to be used for transmission to a UE group |
| 2_2 | Used for transmission of a transmission power control (TPC) for a PUCCH |
| | and a PUSCH |
| 2_3 | Used for transmission of a TPC command group for SRS transmission by one |
| | or more UEs |
| 2_4 | Used for a UE to notify PRB(s) and OFDM symbol(s) for which UL |
| | transmission from the UE is cancelled to a UE group |
| 2_5 | Used for notifying availability of soft resources |
| 2_6 | Used for notifying power saving information outside a DRX active time to one |
| | or more UEs |
| 3_0 | Used for NR sidelink scheduling within one cell |
| 3_1 | Used for LTE sidelink scheduling within one cell |

DCI may include downlink control information for one or more cells, and may be associated with one RNTI. The DCI may be encoded through the order of 1) information element multiplexing, 2) cyclic redundancy check (CRC) addition, 3) channel coding, and 4) rate matching, and decoding may also be performed in consideration of the above steps. In the above description, “a certain DCI is associated with one RNTI” may mean that CRC parity bits of the DCI are scrambled with the RNTI. Referring to Table 8, some DCI may include scheduling information of one or more PUSCHs for a certain cell. For example, a CRC of the DCI format 0_1 may be scrambled with a C-RNTI, configured scheduling-RNTI (CS-RNTI), semi-persistent CSI RNTI (SP-CSI-RNTI), or modulation coding scheme cell RNTI (MCS-C-RNTI). The DCI format 0_1 may include at least one of the following information.
Identifier for DCI format (1 bit): Indicator indicating a UL DCI format, which is always set to 0 in the case of DCI format 0_1
Carrier indicator (0 or 3 bits): Indicator indicating a CC scheduled by the corresponding DCI
DFI flag (0 or 1 bit): Configured grant downlink feedback information (CG-DFI) indicator
If the DCI format 0_1 is used for CG-DFI indication (when the DFI flag is set to 1), at least one of the following fields may be used:
HARQ-ACK bitmap (16 bits), where the order of mapping HARQ process indexes within the bitmap is that the HARQ process indexes are mapped from the MSB to the LSB of the bitmap in ascending order. For each bit in the bitmap, a value of 1 indicates ACK, and a value of 0 indicates NACK.
TPC command for a scheduled PUSCH (2 bits)
All the remaining bits in the DCI format 0_1 are set to zero
If the DCI format 0_1 is not used for CG-DFI indication (when there is no DFI flag field or DFI flag field is set to 0), at least one of the following fields may be used:
UL/SUL indicator (0 or 1 bit): supplementary UL indicator.
Bandwidth part indicator (0, 1, or 2 bits): Indicator indicating a BWP to be activated among uplink BWPs configured for the terminal.
Frequency domain resource assignment: Indicator for allocating a frequency domain resource.
Time domain resource assignment: Indicator for allocating a time domain resource.
Frequency hopping flag (0 or 1 bit): Frequency axis hopping indicator
Modulation and coding scheme (5 bits)
New data indicator (NDI): Indicator indicating whether allocated data is new data or retransmission data.
Redundancy version (RV): Indicator indicating an RV value when channel coding is applied to allocated data
HARQ process number (4 bits): Indicator indicating a HARQ process to be allocated to scheduled data
TPC command for a scheduled PUSCH (2 bits): TPC indicator
SRS resource indicator: Aperiodic SRS resource selection indicator
Precoding information and number of layers: Indicator indicating precoding and the number of transport layers to be used in PUSCH transmission
Antenna ports: Indicator for uplink antenna ports to be used for PUSCH transmission
SRS request: Indicator indicating whether to transmit aperiodic SRS
CSI request: Indicator indicating whether and how to report channel state information
PTRS-DMRS association: Indicator indicating a relationship between an uplink phase-noise tracking reference signal (PTRS) antenna port and a demodulation reference signal (DMRS) antenna port
DMRS sequence initialization: Indicator for a DMRS sequence initialization value during OFDM-based uplink transmission
UL-SCH indicator: Indicator indicating whether or not an uplink shared channel (UL-SCH) is included in a PUSCH (a PUSCH that does not include a UL-SCH needs to include CSI)
Open-loop power control parameter set indication: Indicator indicating a set of open-loop power control (OPLC) parameter set
Priority indicator: Uplink transmission priority indicator
Invalid symbol pattern indicator: Indicator indicating whether to apply an invalid symbol pattern configured by a higher layer

As another example, a CRC of the DCI format 11 may be scrambled with a C-RNTI, CS-RNTI, or MCS-C-RNTI, and the DCI format 1_1 may include at least one of the following information.
Identifier for DCI format (1 bit): Indicator indicating a DL DCI format, which is always set to 1 in the case of DCI format 1_1
Carrier indicator (0 or 3 bits): Indicator indicating a CC scheduled by the corresponding DCI
Bandwidth part indicator (0, 1, or 2 bits): Indicator indicating a BWP to be activated among downlink BWPs configured for the terminal
Frequency domain resource assignment: Indicator for allocating a frequency domain resource
Time domain resource assignment: Indicator for allocating a time domain resource
PRB bundling size indicator: Indicator indicating a type (i.e. static or dynamic) and a size of PRB bundling
Rate matching indicator: Indicator indicating a rate matching pattern configured by a higher layer
ZP CSI-RS trigger: Indicator for applying aperiodic zero-power (ZP) CSI-RS
‘modulation and coding scheme’, ‘new data indicator’, and ‘redundancy version’ fields for a transport block 1
‘modulation and coding scheme’, ‘new data indicator’, and ‘redundancy version’ fields for a transport block 2
HARQ process number: Indicator indicating a HARQ process to be allocated to scheduled data
Downlink assignment index: DAI indicator for HARQ-ACK codebook generation in TDD operation
TPC command for a scheduled PUCCH: Power control indicator for PUCCH transmission
PUCCH resource indicator: Indicator indicating a PUCCH resource for transmitting HARQ-ACK information for an allocated PDSCH or a predetermined PDSCH set
PDSCH-to-HARQ_feedback timing indicator: Indicator indicating a time axis offset between the allocated PDSCH and the PUCCH
Antenna port(s): Indicator indicating antenna ports to be used for PDSCH transmission/reception
Transmission configuration indication: Indicator indicating transmission configuration information (TCI) to be used for PDSCH transmission and reception
SRS request: Indicator indicating whether to transmit aperiodic SRS
DMRS sequence initialization: Indicator for a DMRS sequence initialization value used for PDSCH transmission and reception
Priority indicator: PDSCH reception priority indicator

As another example, certain DCI formats may be used to deliver the same control information to one or more terminals. For example, a CRC of the DCI format 2_3 may be scrambled with a transmit power control-sounding reference signal-RNTI (TPC-SRS-RNTI), and may include at least one of the following information.
Block number 1, Block number 2, . . . , Block number B: Indicators indicating resource regions to which the DCI format 2_3 is applied. A starting part of the block is configured by a higher layer parameter startingBitOfFormat2-3 or startingBitOfFormat2-3SUL-v1530.
When a terminal for which a higher layer parameter srs-TPC-PDCCH-Group is set to type A performs uplink transmission without a PUCCH and PUSCH or uplink transmission in which SRS power control is not tied to PUSCH power control, one block is configured by the higher layer, and the following fields are defined for the block.
SRS request (0 or 2 bits): Aperiodic SRS transmission indicator
TPC command number 1, TPC command number 2, . . . ,TPC command number N: Indicators indicating uplink power control to be applied to a UL carrier indicated by a higher layer parameter cc-IndexInOneCC-Set.
When a terminal for which a higher layer parameter srs-TPC-PDCCH-Group is set to type B performs uplink transmission without a PUCCH and PUSCH or uplink transmission in which SRS power control is not tied to PUSCH power control, one or more blocks may be configured by the higher layer, and the following fields are defined for each block.
SRS request (0 or 2 bits): Aperiodic SRS transmission indicator.
TPC command (2 bits)

As another example, certain DCI formats may be used to deliver the same control information to more than one terminal. For example, a CRC of a DCI format 20 may be scrambled with an SFI-RNTI and may be used to notify information such as slot format(s), channel occupancy time (COT) duration(s), available RB set(s), and search space set group switching. Specifically, the DCI format 2_0 may include at least one of the following information.
If a higher layer parameter slotFormatCombToAddModList is configured,
Slot format indicator 1, Slot format indicator 2, . . . , Slot format indicator N
If a higher layer parameter availableRB-SetsToAddModList-r16 is configured,
Available RB set indicator 1, Available RB set indicator 2, . . . , Available RB set indicator N1
If a higher layer parameter co-DurationsPerCellToAddModList-r16 is configured,
COT duration indicator 1, COT duration indicator 2, . . . , COT duration indicator N2
If a higher layer parameter searchSpaceSwitchTriggerToAddModList-r16 is configured,
Q Search space set group switching flag 1, Search space set group switching flag 2, . . . , Search space set group switching flag M

The size of DCI format 2_0 may be set by a higher layer as one of values up to 128 bits. For example, a DCI format 2_5 may be used to notify availability of soft type resources of an JAB node. A CRC of the DCI format 2_5 may be scrambled with an availability indicator (AI)-RNTI and may include information below.
Q Availability indicator 1, Availability indicator, . . . , Availability indicator N

The size of DCI format 2_5 may set by a higher layer as one of values less than or equal to 128 bits.

The terminal may receive configuration information of a CORESET #0 and a search space #0, identical or similar to that shown in Table 9.

TABLE 9

```
PDCCH-ConfigSIB1 ::= SEQUENCE {
  controlResourceSetZero
  searchSpaceZero
}
ControlResourceSetZero // indicates a configuration value (0~15) of a CORESET #0 within
an initial BWP
Search SpaceZero // indicates a configuration value (0~15) of a search space #0 within an
initial BWP
```

The terminal may refer to the following higher layer configurations for cell-specific PDCCH monitoring, identical or similar to those shown in Tables 10 to 13.

TABLE 10

```
PDCCH-ConfigCommon ::= SEQUENCE {
  controlResourceSetZero // indicates a configuration value (0~15) of a CORESET #0 within
an initial BWP
  commonControlResourceSet
      // configure a common CORESET by referring to CORESET configuration
search SpaceZero // indicates a configuration value (0~15) of a search space #0 within an
initial BWP
  commonSearchSpaceList // configures a search sapce to be used for cell-specific PDCCH
monitoring by referring to up to four search space configurations
search SpaceSIB1 // search space configuration for SIB1
searchSpaceOtherSystemInformation // search space configuration for SIB2 or other SIBs
pagingSearchSpace // search space configuration for paging
  ra-SearchSpace // search space configuration for random access procedure
  ...
}
```

TABLE 11

```
ControlResourceSet ::= SEQUENCE {
  controlResourceSetId // CORESET ID (a value other than 0 is used)
frequencyDomainResources // configuration of frequency resources of a CORESET
  duration // configuration of a time-axis length (symbols) of a CORESET
cce-REG-MappingType CHOICE { // CCE-to-REG mapping configuration
    interleaved SEQUENCE {
      reg-BundleSize
      interleaverSize
      shiftIndex
    },
    nonInterleaved
  },
  precoderGranularity
  tci-StatesPDCCH-ToAddList
// indicates a QCL relation possible between a QCL reference RS and a PDCCH DMRS
tci-StatesPDCCH-ToReleaseList
  tci-PresentInDCI // indicates whether a TCI field exists within the DCI format 1_1
pdcch-DMRS-ScramblingID // indicates a scrambling initialization value of a PDCCH DMRS
...
}
```

```
TABLE 12
SearchSpace ::= SEQUENCE {
  searchSpaceId // search space ID
  controlResourceSetId // CORESET ID associated with the search space
monitoringSlotPeriodicityAndOffset CHOICE { // periodicity and offset of a PDCCH
monitoring slot
sl1 // performs PDCCH monitoring in every slot
...
// (omitted) monitoring offset values when a PDCCH monitoring periodicity is one of 2 to 1280
slots
    sl2560 // a monitoring offset value when a PDCCH monitoring periodicity is 2560 slots
  }
  duration // the number of slots where a search space exists for each occasion

[symbol]

  monitoringSymbolsWithinSlot
// a position of a first symbol on which monitoring is to be performed within a PDCCH
monitoring slot
nrofCandidates SEQUENCE {
      aggregationLevel1 // The number of PDCCH candidates in case of aggregation level 1
aggregationLevel2 // The number of PDCCH candidates in case of aggregation level 2
      aggregationLevel4 // The number of PDCCH candidates in case of aggregation level 4
      aggregationLevel8 // The number of PDCCH candidates in case of aggregation level 8
      aggregationLevel16 // The number of PDCCH candidates in case of aggregation level
16
  }
  searchSpaceType CHOICE { // indicates a search space type (common or UE-
specific) and DCI formats
```

TABLE 13

```
common SEQUENCE {
      dci-Format0-0-AndFormat1-0 SEQUENCE {
        ...
      }
      dci-Format2-0 SEQUENCE {
        nrofCandidates-SFI SEQUENCE {
          ...
        },
        ...
      }
      dci-Format2-1
      dci-Format2-2
      dci-Format2-3 SEQUENCE {
        dummy1
        dummy2
      }
    },
    ue-Specific SEQUENCE {
      dci-Formats
      ...,
    }
  }
}
```

The terminal may refer to the following higher layer configurations for UE-specific PDCCH monitoring, identical or similar to those shown in Table 14.

TABLE 14

```
PDCCH-Config ::= SEQUENCE {
  controlResourceSetToAddModList
// At most three CORESETs are configured by referring to CORESET configuration
controlResourceSetToReleaseList
  search SpacesToAddModList
// At most ten search spaces are configured by referring to search space configuration
searchSpacesToReleaseList
  downlinkPreemption // downlink preemption indicator
tpc-PUSCH // configuraion of reception of a group TPC for PUSCH transmission
tpc-PUCCH // configuration of reception of a group TPC for PUCCH transmission
tpc-SRS // configuration of reception of a group TPC for SRS transmission
...,
}
```

The presence of one antenna port may mean a case in which a channel experienced by a symbol transmitted through the corresponding antenna port can be estimated or inferred from a channel experienced by another symbol transmitted through the same antenna port.

“Two different antenna ports are quasi co-located (QCLed)” may mean a case in which large-scale characteristics of a channel experienced by a symbol transmitted through one antenna port can be estimated or inferred from a channel experienced by a symbol transmitted through another antenna port. The large-scale characteristics of the channel may mean at least one of ‘delay spread’, ‘Doppler spread’, ‘Doppler shift’, ‘average gain’, ‘average delay’, and ‘spatial Rx parameters’.

When time/frequency resources of a certain signal (e.g. QCL target RS) are insufficient and large-scale characteristics of a channel cannot be accurately measured with only the corresponding signal, information (i.e. QCL information) on another signal (e.g. QCL reference RS having sufficient time/frequency resources) having large-scale characteristics that can be reused for reception of the corresponding signal (i.e. QCL target RS) may be provided to the terminal to improve the channel measurement performance of the terminal. The NR communication system may support various QCL types as follows.

- QCL-Type A: including {Doppler shift, Doppler
spread, average delay, delay spread}.
- QCL-Type B: including {Doppler shift, Doppler spread}
- QCL-Type C: including {Doppler shift, average delay}
- QCL-Type D: including {Spatial Rx parameters}

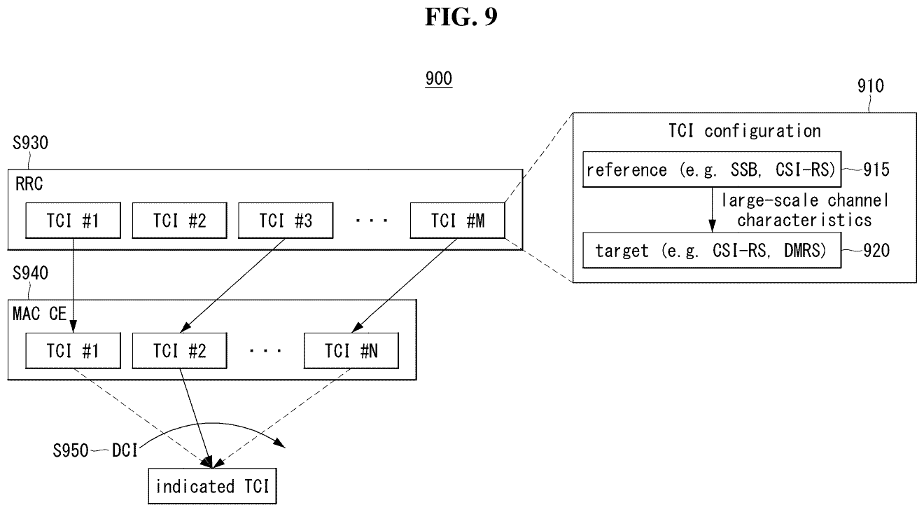

FIG. 9 is a conceptual diagram illustrating an exemplary embodiment of a QCL information transfer process through TCI state configuration and indication in a communication system.

Referring to FIG. 9, in a process of transmitting QCL information through TCI state configuration and indication in a communication system 900, a base station may configure at most M TCI states to a terminal through higher layer (i.e. RRC) signaling, in accordance with a UE capability report and a maximum value (e.g. 4, 8, 64, or 128 depending on a frequency band) defined in a technical specification (S930). In this case, each TCI state configuration 910 may include information on a signal or channel (i.e. QCL reference 915) that provides large-scale channel characteristics to a signal or channel (i.e. QCL target 920) referring to the TCI. One TCI state configuration 910 may include up to two references (i.e. qcl-Type1 and qcl-Type2), the first reference may be one of the QCL-Type A, QCL-Type B, and QCL-type C (i.e. qcl-type1∈{QCL-type A, QCL-type B, QCL-type C}), and the second reference may be the QCL-type D if present (i.e. qcl-type 2=QCL-type D).

Allowing the base station to apply all the TCIs configured through the RRC signaling in real time may greatly increase implementation complexity of the terminal, the base station may transmit an activation message for some of the TCIs configured through the RRC signaling to the terminal through L2 signaling such as a MAC CE (S940). The base station may activate a maximum of N (<M) TCIs, and the terminal may receive a dynamic indication only for the activated TCI.

Thereafter, the base station may dynamically indicate to the terminal some of the activated N TCIs through L1 signaling such as a DCI (S950). The terminal may apply QCL information indicated by the corresponding TCI at a predetermined timing after receiving the L1 signaling, and may perform a reception operation for the signal or channel.

The TCI state indication steps including the ‘RRC signaling (S930)’, ‘MAC CE signaling (S940)’, and ‘DCI signaling (S950)’ of FIG. 9 may be partially omitted depending on a type of the QCL target RS. For example, when the QCL target is a PDSCH DMRS, and one or more TCI states are configured through RRC signaling, the base station may indicate the TCI state using all the steps of FIG. 9. However, when the QCL target is a PDSCH DMRS, and a single TCI state is configured through RRC signaling, the MAC CE signaling (S940) and the DCI signaling step (S950) may be omitted. Similarly, when the QCL target is a PDCCH DMRS, the DCI signaling step S940 may be omitted. Specifically, the terminal may obtain configuration information for the TCI states and QCL information with reference to the RRC signaling identical or similar to those shown in Table 15.

TABLE 15

```
TCI-State ::= SEQUENCE { // TCI configuration (I.1-00)
  tci-StateId // TCI state ID
  qcl-Type1 // first QCL reference configured by referring to QCL information
qcl-Type2 // second QCL reference configured by referring to QCL information
  ...
}
QCL-Info ::= SEQUENCE {
  cell // index of a cell in which QCL reference is transmitted
  bwp-Id // index of a BWP in which QCL reference is transmitted
referenceSignal CHOICE {
    csi-rs // index of a CSI-RS to be referred when QCL reference is a CSI-RS
ssb // index of an SSB to be referred when QCL reference is an SSB
  },
  qcl-Type
  // QCL type to be applied to a QCL target (one of QCL-type A, QCL-type B, QCL-type C,
and QCL-type D)
  ...
}
```

The base station may instruct the terminal to activate or deactivate some of the TCI states configured by the RRC signaling through MAC CE signaling, or may instruct the terminal to apply a TCI state indicated by a MAC CE to the QCL target RS. For example, the base station may use the following MAC CE signaling according to the type of the QCL target RS.
TCI state activation/deactivation MAC CE for a UE-specific PDSCH DMRS
TCI state indication MAC CE for a UE-specific PDCCH DMRS
TCI state activation/deactivation MAC CE for an enhanced UE-specific PDSCH DMRS

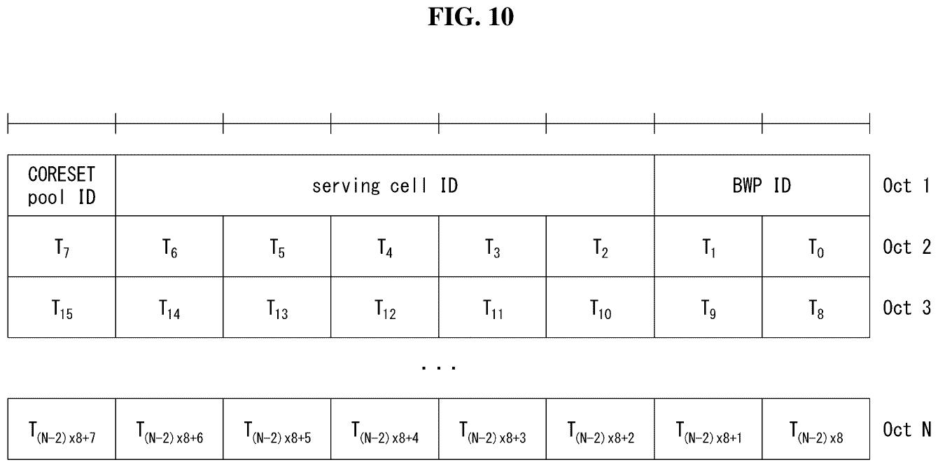

FIG. 10 is a conceptual diagram illustrating an exemplary embodiment of a TCI state activation/deactivation MAC CE in a communication system.

Referring to FIG. 10, a first octet (Oct 1) in a TCI state activation/deactivation MAC CE for a UE-specific PDSCH DMRS may include a CORSET pool ID field 1010, a serving cell ID field 1020, and a BWP ID field 1030, and a second octet (Oct 2) to an N-th octet (Oct N) may include Ti fields 1040 indicating TCI state IDs i. The detailed meaning of each field may be as follows, and the sizes thereof may be variable.
Serving cell ID: a serving cell ID to which the MAC CE is applied
BWP ID: BWP ID to which the MAC CE is applied, which indicates a BWP in association with a BWP indication field within the DCI
Ti: indicates a TCI state ID i. When this value is set to 0, it may mean that a TCI state whose TCI state ID is i is deactivated, and when this value is set to 1, it may mean that a TCI state whose TCI state ID is i is activated. The TCI states activated by 1 may be sequentially mapped to TCI indication field code points within the DCI.
CORESET pool ID: If a DCI scheduling a PDSCH is monitored in a CORESET that does not include a higher layer parameter coresetPoolIndex, the field may be ignored. If a DCI scheduling a PDSCH is monitored in a CORESET including the higher layer parameter coresetPoolIndex, Ti indication may be applied only when a value of the CORESET pool ID matches a value of coresetPoolIndex of the CORESET.

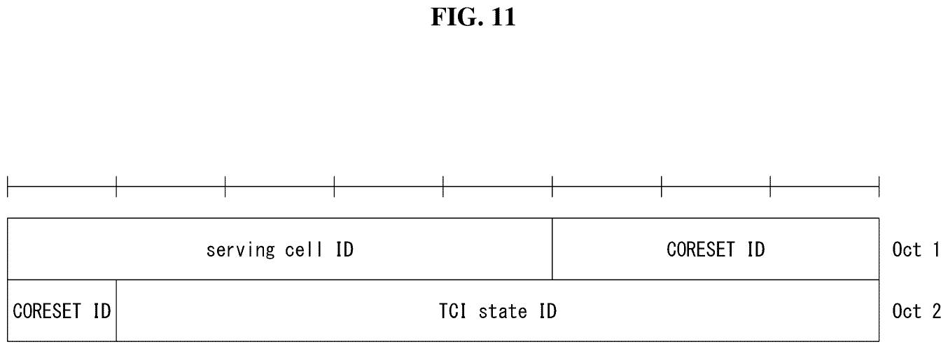

FIG. 11 is a conceptual diagram illustrating an exemplary embodiment of a TCI state indication MAC CE in a communication system.

Referring to FIG. 11, a first octet (Oct 1) in a TCI state activation/deactivation MAC CE for a UE-specific PDSCH DMRS may include a serving cell ID field 1110 and a CORESET ID field 1120, and a second octet (Oct 2) may include a CORESET ID field 1130 and a TCI state ID field 1140. The sizes thereof may be variable.
Serving cell ID: a serving cell ID to which the corresponding MAC CE is applied.
CORESET ID: indicates a CORESET to which the MAC CE is applied. If this value is set to 0, a CORESET configured through controlResourceSetZero may be a CORESET #0.
TCI state ID: means a TCI state ID indicated by the corresponding MAC CE.

The base station may configure spatial relation information to the terminal through higher layer (e.g. RRC) signaling in order to indicate uplink beam information. The spatial relation information may mean a signaling structure for using spatial domain filters used for transmission and reception of a reference RS for spatial TX filters for uplink transmission of a target RS according to the corresponding spatialrelation. The spatialreference RS may be a downlink signal such as SSB or CSI-RS, and may also be an uplink signal such as SRS. If the reference RS is a downlink signal, the terminal may use the spatial RX filter values used for receiving the reference RS as spatial TX filter values for transmitting the target RS according to the spatial relation. If the reference RS is an uplink signal, the terminal may use the spatial TX filter values used for transmitting the reference RS as the spatial TX filter values for transmitting the target RS according to the spatial relation.

The signaling structure for the spatial relation information may vary depending on the type of target RS. For example, when the target RS is an SRS, the base station may perform RRC configuration for each SRS resource based on message identical or similar to those shown in Table 16.

TABLE 16

```
SRS-SpatialRelationInfo ::=  SEQUENCE
  servingCellId // index of a serving cell in which a reference RS is transmitted
  referenceSignal CHOICE {
    ssb-Index // SSB index when a reference RS is SSB
    csi-RS-Index // CSI-RS resource index when a reference RS is CSI-RS
srs SEQUENCE {
            resourceId // SRS resource index when a reference RS is SRS
uplinkBWP // index of a UL BWP in which SRS is transmitted when a reference RS is SRS
}
  }
}
```

For example, when the target RS is an SRS, the base station may perform RRC configuration for each SRS resource, identical or similar to those shown in Table 17.

TABLE 17

```
PUCCH-SpatialRelationInfo ::= SEQUENCE {
  pucch-SpatialRelationInfoId // spatial relation information ID for PUCCH
  servingCellId // index of a serving cell in which a reference RS is transmitted
referenceSignal CHOICE {
    ssb-Index // SSB index when a reference RS is SSB
    csi-RS-Index // CSI-RS resource index when a reference RS is CSI-RS
    srs // specifiy a SRS resource by referring to PUCCH-SRS configuration
},
  pucch-PathlossReferenceRS-Id
// index of a RS resource to be used for measurement of a pathloss of a PUCCH
p0-PUCCH-Id // index of confuring p0 for PUCCH power control
closedLoopIndex // configuration value of closed-loop power control
}
PUCCH-SRS ::= SEQUENCE {
  resource // SRS resource index
  uplinkBWP // index of a BWP in which SRS is transmitted
}
```

In the 5G NR communication system, a slot format may include downlink symbol(s), uplink symbol(s), and/or flexible symbol(s).

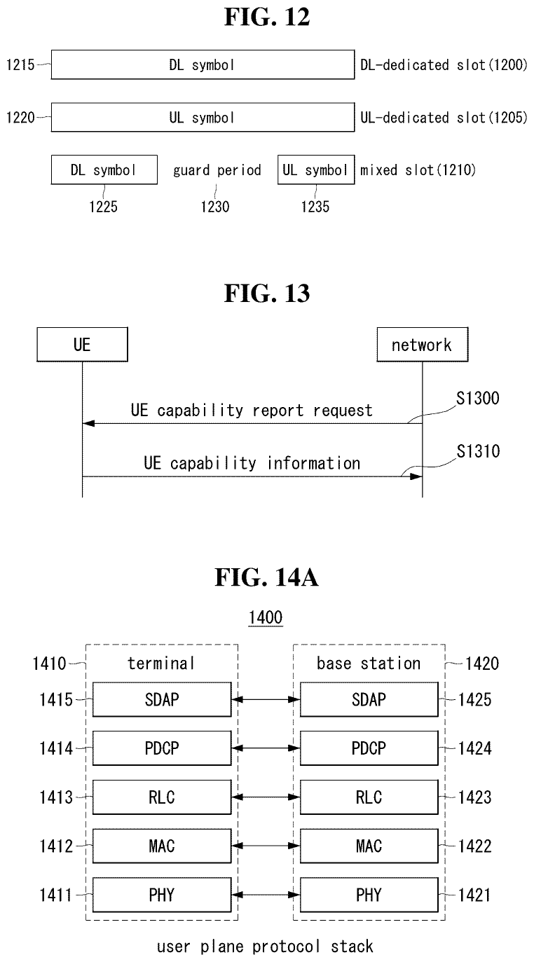

FIG. 12 is a conceptual diagram illustrating slot configurations according to slot formats in a communication system.

Referring to FIG. 12, in slot configurations according to slot formats in a communication system, a downlink dedicated slot 1200 may be a slot in which all symbols within the slot are configured only as downlink symbols 1215 according to a slot format. As another example, an uplink dedicated slot 1205 may be a slot in which all symbols within the slot are configured only as uplink symbols 1220 according to a slot format. As another example, in a downlink/uplink mixed slot 1210, some symbols within the slot may be configured as downlink symbols 1225, and some symbols within the slot may be configured as uplink symbols 1235 according to a slot format. In this case, specific symbols of the mixed slot 1210 including both the uplink and downlink symbols may be configured or indicated as a guard period 1230 for downlink-uplink switching, and the terminal may not perform transmission/reception during the guard period 1230.

In the 5G NR communication system, the base station may configure a ‘slot format’ over one or more slots for each serving cell to the terminal through a higher layer parameter tdd-UL-DL-ConfigurationCommon. In this case, the higher layer parameter tdd-UL-DL-ConfigurationCommon may include or refer to at least one of the following information.
Reference subcarrier spacing: reference numerology μ_{ref}
Pattern 1: A first pattern.
Pattern 2: A second pattern.

Here, the pattern 1 or pattern 2 may include at least one of the following configurations.
Slot configuration periodicity (i.e. dl-UL-TransmissionPeriodicity): Slot configuration periodicity P expressed in units of msec
Number of downlink dedicated slots (i.e. nrofDownlinkSlots): The number dₛₗₒₜₛ of slots composed only of downlink symbols
Number of downlink symbols (i.e. nrofDownlinkSymbols): The number d_{sym} of downlink symbols
Number of uplink dedicated slots (i.e. nrofUplinkSlots): The number uₛₗₒₜₛ of slots composed only of uplink symbols
Number of uplink symbols (i.e. nrofUplinkSymbols): The number u_{sym} of uplink symbols

The slot configuration periodicity P msec of the first pattern may include S=P·2^{μ}^{_{ref}} slots, and in this case, the numerology may follow μ_{ref}. In addition, among the S slots, the first dₛₗₒₜₛ slots may include only downlink symbols, and the last uₛₗₒₜₛ slots may include only uplink symbols. In this case, d_{sym} symbols after first dₛₗₒₜₛ slots may be downlink symbols. In addition, u_{sym} symbols before last uₛₗₒₜₛ slots may be uplink symbols. The remaining symbols (i.e.

$$( i . e . ( S - {d}_{slots} - {u}_{slots} ) \cdot {N}_{s y m b}^{slot} - {d}_{s y m} - {u}_{s y m} symbols )$$

that are not designated as downlink symbols or uplink symbols in the pattern may be flexible symbols.

If the second pattern is configured and the slot configuration periodicity of the second pattern is P₂, a slot configuration periodicity P+P₂ msec configured with a combination of the first pattern and the second pattern may include first S=P·2^{μ}^{_{ref}} slots and second S₂=P₂·2^{μ}^{_{ref}} slots. In this case, the positions and numbers of downlink symbols, uplink symbols, and flexible symbols in the second pattern may be configured with reference to the description of the first pattern based on configuration information of the second pattern. In addition, when the second pattern is configured, the terminal may assume that P+P₂ is a divisor of 20 msec.

The base station may override direction(s) of ‘flexible symbol(s)’ among symbols configured through the higher layer parameter tdd-UL-DL-ConfigurationCommon by using the higher layer parameter tdd-UL-DL-ConfigurationDedicated) based on the following information.
Slot configuration set (i.e. slotSpecificConfigurationsToAddModList): A set of slot configurations
Slot index (i.e. slotIndex): An index of a slot included in the set of slot configurations
Symbol directions (i.e. symbols): The directions of the symbols indicated by the slot index (i.e. slotIndex). If all symbol directions are downlink (symbols=allDownlink), all symbols within the corresponding slot are downlink symbols. If all symbol directions are uplink (symbols=allUplink), all symbols within the corresponding slot are uplink symbols. If the symbol directions are explicit (symbols=explicit), nrofDownlinkSymbols may indicate the number of downlink symbols located in the first part of the corresponding slot, and nrofUplinkSymbols may indicate the number of uplink symbols located in the last part of the corresponding slot. If nrofDownlinkSymbols or nrofUplinkSymbols is omitted, the corresponding parameter may be regarded as indicating a value of 0. The remaining symbols within the slot become flexible symbols.

In the 5G communication system, the base station may indicate a slot format to the terminal based on L1 signaling. For example, when the terminal receives a higher layer parameter SlotFormatIndicator from the base station, the terminal may obtain configuration information a slot format indication-RNTI (i.e. SFI-RNTI). Meanwhile, when the terminal receives a higher layer parameter dci-PayloadSize from the base station, the terminal may obtain configuration information of a payload size of the DCI format 2_0. In addition, the terminal may additionally receive, from the base station, information on PDCCH candidate(s), CCE aggregation level, and search space set(s) of a CORESET for monitoring the DCI format 2_0. Each slot format indication (SFI) index field in the DCI format 2_0 may indicate a slot format to be applied to each slot in a slot set of a DL BWP and a UL BWP from a slot in which the terminal has detected the corresponding DCI format 2_0. In this case, the size of the slot set may be equal to or greater than a PDCCH monitoring periodicity of the DCI format 2_0. For example, when the slot set is composed of N slots, the DCI format 20 may include N SFI index fields, and each SFI index field may indicate a format value of Tables 18 to 20 below. In Tables 18 to 20, ‘D’ may mean a downlink symbol, ‘U’ may mean an uplink symbol, and ‘F’ may mean a flexible symbol.

TABLE 8

| Slot | Symbol number within a slot | | | | | | | | | | | | | |
|---|---|---|---|---|---|---|---|---|---|---|---|---|---|---|
| format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |

TABLE 19

| Slot | Symbol number within a slot | | | | | | | | | | | | | |
|---|---|---|---|---|---|---|---|---|---|---|---|---|---|---|
| format | 0 | 1 | 2 | 3 | 4 | 5 | 6 | 7 | 8 | 9 | 10 | 11 | 12 | 13 |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | IF | F | U | U | U | U | U | U | U | U | U |

TABLE 20

| Slot | Symbol number within a slot | | | | | | | | | | | | | |
|---|---|---|---|---|---|---|---|---|---|---|---|---|---|---|
| format | 0 | 1 | 2 | 3 | 4 | 5 | 6 | 7 | 8 | 9 | 10 | 11 | 12 | 13 |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56- | Reserved |
| 254 | |
| 255 | UE determines a slot format of a slot based on |
| | a higher layer parameter tdd-UL-DL- |
| | ConfigurationCommon or a higher layer |
| | parameter tdd-UL-DL-ConfigurationDedicated, |
| | and a detected DCI format (when exists). |

FIG. 13 is a sequence chart illustrating an exemplary embodiment of a UL capability reporting procedure in a communication system.

Referring to FIG. 13, in the UL capability reporting procedure, the base station may transmit a UL capability report request signal to the terminal through a higher layer parameter UECapabilityEnquiry when the terminal is in RRC connected mode (i.e. RRC_CONNECTED state) (S1300). In this case, the network may refer to only the UL capability report after access stratum (AS) security activation, and may not retransmit or report the UL capability report before the AS security activation to the core network (CN). Upon receiving the UL capability report request signal, the terminal may compile UL capability information according to a specific procedure, and report it to the base station through a UL capability information signal (e.g. UECapabilityInformation) (S1310).

The specific procedure for compiling the UL capability information signal may include a procedure of generating at least one of a list (i.e. supportedBandCombinationList) of band(s) or band combination(s) (BC(s)) supported by the terminal, feature set (FS) information related to feature sets supported by the terminal, or feature set combination (FSC) information related to feature set combinations supported by the terminal. For example, when the base station requests a UE capability report from the terminal in order to obtain information on band(s) or band combination(s) supported by the terminal, the terminal may report which band(s) it supports for each radio access technology (RAT). To this end, the base station may set a RAT-type in a UE RAT capability report request signal (e.g. UE-CapabilityRAT-Request), which is included in a UE RAT capability report request list signal (e.g. ue-CapabilityRAT-RequestList) that is a higher layer message, to one of ‘nr’, ‘eutra-nr’, ‘eutra’, and ‘eutra-fdd’. This may mean that the base station may request a UE capability report for one or more RATs or RAT combinations from the terminal, and in this case, the terminal may respond to each request for a list of support bands for a plurality of RATs or RAT combinations. For example, if the RAT-type is set to ‘nr’, the terminal may include a list of bands or band combinations to which NR-DC can be applied in the UE capability report. As another example, if the RAT-type is set to ‘eutra-nr’, the terminal may include a list of bands or band combinations applicable to multi-RAT DC (MR-DC) such as EN-DC, NGEN-DC, NE-DC, or the like in the UE capability report. In addition, when the base station requests a UE capability report, the base station may provide, to the terminal, a list of bands for which the terminal determines whether support is provided, through a higher layer parameter frequencyBandListFilter. For the bands included in the higher layer parameter frequencyBandListFilter, the terminal may determine a candidate band combination by considering ‘predetermined RAT types supported for each band’, ‘information on RAT-types requested by the base station’, etc., and may include the candidate band combination in the UE capability report.

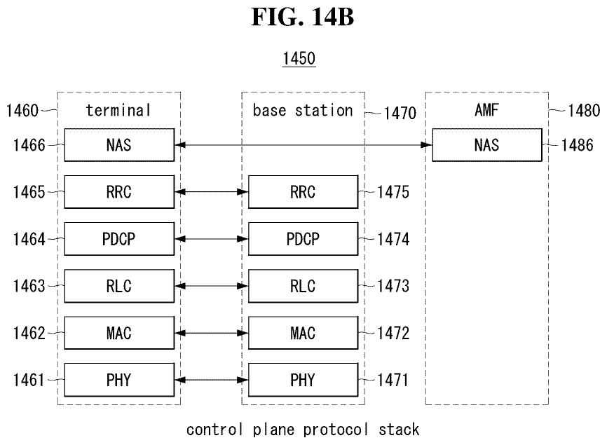

FIGS. 14A and 14B are conceptual diagrams for describing a first exemplary embodiment of a user plane protocol stack structure and a control plane protocol stack structure in a communication system.

Referring to FIGS. 14A and 14B, a radio interface protocol stack or radio interface protocol stack structures 1400 and 1450 may be defined in a radio connection section between communication nodes. For example, the radio interface protocol stack may be divided into a physical layer, a data link layer, a network layer, and the like, which are vertically configured.

The radio interface protocol stack may be divided into the user plane protocol stack 1400 and the control plane protocol stack 1450. Here, the control plane may be a plane for transmitting a control signal. The control signal may be referred to as a signaling signal. The user plane may be a plane for transmitting user data.

Referring to FIG. 14A, the communication system may include a terminal 1410 and abase station 1420. The terminal 1410 may be referred to as a user equipment (UE). The base station 1420 may correspond to an eNB, a gNB, or the like. The terminal 1410 and the base station 1420 may perform mutual data signal transmission/reception based on the user plane protocol stack structure 1400 shown in FIG. 14A.

In the user plane air interface protocol stack structure 1400 of the communication system, the terminal 1410 and the base station 1420 may include PHY layers 1411 and 1421 included in L1, MAC layers 1412 and 1422, RLC layers 1413 and 1423, and packet data convergence protocol (PDCP) layers 1414 and 1424 included in L2, service data adaptation protocol (SDAP) layers 1415 and 1425 included in L3, and the like.

Referring to FIG. 14B, the communication system may include a terminal 1460 and a base station 1470. The terminal 1460 and the base station 1470 may perform mutual control signal transmission/reception based on the control plane protocol stack structure 1450 shown in FIG. 14B.

In the control plane protocol stack structure 1450 of the communication system, the terminal 1460 and the base station 1470 may include PHY layers 1461 and 1471 included in L1, MAC layers 1462 and 1472, RLC layers 1463 and 1473, and PDCP layers 1464 and 1474 included in L2, and RRC layers 1465 and 1475 included in L3, and the like.

The communication system may further include an Access and Management Mobility Function (AMF) 1480. In the control plane protocol stack structure 1450, the terminal 1460 and the AMF 1480 may include non-access stratum (NAS) layers 1466 and 1486. The base station 1470 may not include a NAS layer. In other words, in the control plane protocol stack structure 1450, the NAS layer of the base station 1470 may be transparent.

The main features of the respective layers of FIGS. 14A and 14B will be described.

In the SDAP layers 1415 and 1425, a single SDAP entity may be configured for each protocol data unit (PDU) session, and in case of dual connectivity (DC), two entities may be configured. In addition, the SDAP layers 1415 and 1425 may provide Quality of Service (QoS) flows to the 5G core network (5GC) through the following elements:
Improves a QoS flow of a data radio bearer.
DL activates a QoS flow identifier (QFI) for UL implementation.

The PDCP layers 1414 and 1424 for the user plane may provide radio bearers to the SDAP layers 1415 and 1425 through the elements described below.
Sequence numbering
Header compression and decompression
Transfer of user data
Reordering and duplicate detection
PDCP PDU routing
Retransmission of PDCP SDUs
Ciphering and Deciphering
PDCP SDU discard
PDCP re-establishment and data recovery for RLC AM
Duplication of PDCP PDUs

The PDCP layers 1464 and 1474 for the control plane may provide radio bearers to the RRC layers through the elements described below.
Sequence Numbering
Ciphering, deciphering and integrity protection
Transfer of control plane data
Duplicate detection
Duplication of PDCP PDUs

The RRC layers 1765 and 1775 may perform the following operations.
Broadcast of System Information related to AS and NAS
Paging initiated by 5GC or NG-RAN
Establishment, maintenance, and release of RRC connections between a user equipment (UR) and a next generation radio access network (NG-RAN), including addition, modification, and release of carrier aggregation (CA) between NR(s) or E-UTRA(s), and addition, modification, and release of dual connectivity (DC) between NR(s) or E-UTRA(s).
Security functions including key management
Establishment, configuration, maintenance, and release of signaling radio bearers (SRBs) and data radio bearers (DRBs)
Mobility functions including handover and context transfer; UE cell selection and reselection and control of cell selection and reselection; inter-RAT mobility
QoS management functions
UE measurement reporting and control of the reporting
Detection of and recovery from radio link failure
NAS message transfer to/from NAS from/to UE

The MAC layers 1412, 1422, 1462, and 1472 may provide logical channels to the RLC layers through the following elements.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between UEs by means of dynamic scheduling
Priority handling between logical channels of one UE by means of logical channel prioritization
Padding

The PHY layers 1411, 1421, 4161, and 1471 may provide transports channel to the MAC layers 1412, 1422, 1462, and 1472, and detailed methods for this are replaced by the overall description of the physical layers in the present disclosure.

The 5G communication system can provide techniques for improving wireless coverage and/or reducing network configuration costs. For example, the 5G communication system can provide integrated access and backhaul (IAB) technology that provides wireless backhaul/fronthaul that can coexist with a radio access network and repeater technology that covers shadow areas at low cost.

In the 5G NR communication system, it may be possible to support flexible and dense wireless backhaul links for each cell without wired network support through the IAB features. Additionally, the protocol structures of FIGS. 14A and 14B can be appropriately changed and applied depending on a situation when applying carrier aggregation (CA) or dual connectivity (DC).

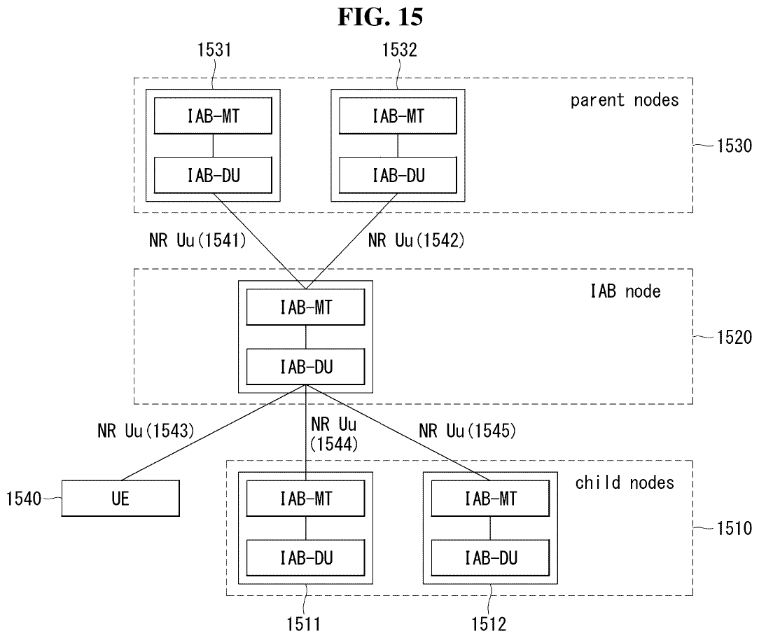

FIG. 15 is a conceptual diagram illustrating an example of network configuration through IAB features.

Referring to FIG. 15, IAB nodes 1511, 1512, 1521, 1531, and 1532 and a terminal 1540 are illustrated. Each of the IAB nodes 1511, 1512, 1521, 1531, and 1532 may be considered a type of relay/repeater configured based on a fronthaul structure. Each the IAB node 1511, 1512, 1521, 1531, and 1532 may be configured with two elements: an IAB-distributed unit (DU) and an IAB-mobile terminal (MT). Depending on their deployment in the network, each of the IAB nodes 1511, 1512, 1521, 1531, and 1532 may act as a parent node or child node.

In FIG. 15, from the perspective of network layers, the IAB node 1521 may belong to an IAB node layer 1520, the IAB nodes 1531 and 1532 may belong to a parent node layer 1530 of the IAB node layer 1520, and the IAB nodes 1511 and 1512 may belong to a child node layer 1510 of the IAB node layer 1520. An IAB-MT of the IAB node 1521 may communicate with IAB-DUs of the IAB nodes 1531 and 1532 of the parent node layer 1530, while an IAB-DU of the IAB node 1521 may communicate with IAB-MTs of the IAB nodes 1511 and 1512 of the child node layer 1510 and a terminal 1540. Therefore, the IAB nodes 1531 and 1532 of the child node layer 1510 and the terminal 1540 may recognize the IAB node 1521 as their cell (serving cell). This implies that the IAB-DU of the IAB-node 1521, the IAB-MTs of the lower nodes, and the terminal 1540 are connected via NR Uu interfaces 1543 to 1545, which are air interfaces between base station and terminal. Similarly, the IAB-MT of the IAB-node 1521 may communicate with the parent nodes, and each of the parent nodes 1531 and 1532 may recognize the IAB-node 1521 as one terminal. Hence, this implies that the parent nodes 1531 and 1532 and the IAB-node 1521 are connected through NR Uu interfaces 1541 and 1542, which are air interfaces.

The IAB node 1521 may be classified as a regenerative relay type, which receives a signal from at least one IAB node among the parent nodes, completely decodes it, re-encodes it, and amplifies/transmits it. For this purpose, the IAB node 1521 may have a protocol stack structure including L1 and L2 layers (and in some cases, L3 or higher layers), and it may support a control plane (CP) and a user plane (UP) from the upper node (e.g. donor IAB node, parent IAB node) to the terminal 1540. This structure offers the advantage of enabling the IAB node to perform various operations, similar to existing base stations and terminals. However, this structure simultaneously increases the implementation complexity and cost of the IAB node and introduces various drawbacks, such as delays required for retransmission.

In contrast to IAB, an RF repeater (e.g. RF relay, etc.) is a type of non-regenerative repeater that simply amplifies and forwards all received signals.

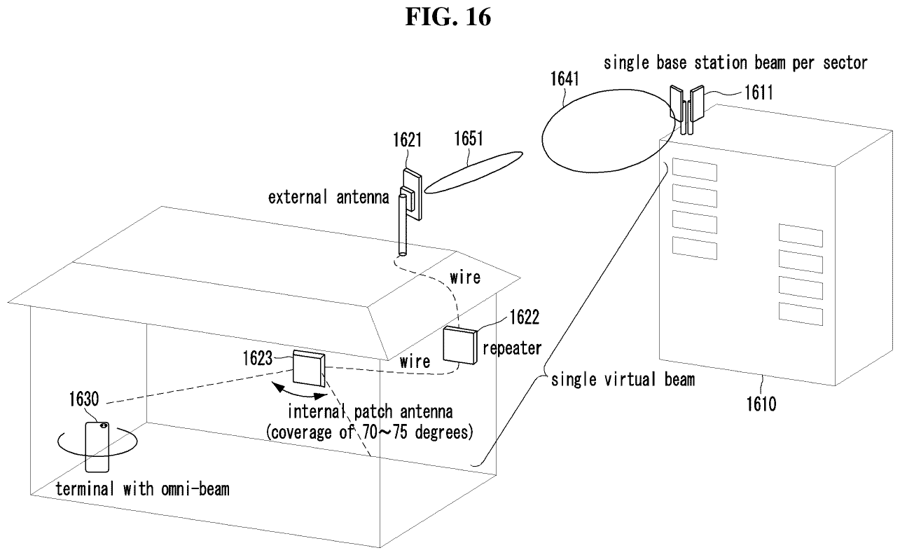

FIG. 16 is a conceptual diagram illustrating deployment of a commercial RF repeater.

Referring to FIG. 16, deployment of a base station 1610 and a commercial RF repeater for receiving wireless signals from the base station 1610 is illustrated. The base station 1610 is exemplified as a base station capable of forming a single beam 1641 for each sector through an antenna 1611. In this case, the base station 1610 may be a base station such as eNB and/or gNB.

In general, the main purpose of commercial RF repeaters is to cover indoor shaded areas. Therefore, the commercial RF repeater may receive signals from the base station 1610 through an outdoor external antenna 1621. The external antenna 1621 may be a directional antenna capable of forming a reception beam 1651 in a specific direction. In addition, the commercial RF repeater may be composed of a repeater unit 1622 that amplifies and retransmits the signals received from the base station, and an indoor patch antenna 1623 that transmits the amplified signals indoors. The external antenna 1621, repeater unit 1622, and internal patch antenna 1623 may be connected through wires as illustrated in FIG. 16. Although FIG. 16 illustrates the case where the external antenna 1621, repeater unit 1622, and internal patch antenna 1623 are connected by wires, they may also be connected wirelessly. Therefore, the internal patch antenna 1623 may perform wireless communication with a terminal 1630. In this case, the terminal 1630 may be a terminal with an omni-beam, as illustrated in FIG. 16, or may be a terminal with a directional beam.

The commercial RF repeater may generally operate in an FR1 band, and in the corresponding frequency band, the base stations 1610 (e.g. eNB, which is an LTE base station, and gNB, which is an NR base station) may operate with one beam per cell or sector. In case of downlink (a link in which signals are transmitted from the base station to the terminal), the external antenna 1621 may be a receiving antenna for receiving signals from the base station, and the internal patch antenna 1623 may be a transmitting antenna for transmitting signals to the terminal 1630. On the other hand, in case of uplink (a link in which signals are transmitted from the terminal to the base station), the external antenna 1621 may be a transmitting antenna, and the internal patch antenna 1623 may be a receiving antenna.

The above-described external antenna 1621, which is generally configured as a directional log-periodic dipole array, may be manually installed to face the direction of the base station. The internal patch antenna 1623, which transmits the amplified/retransmitted signals, may be configured as a patch antenna with an effective coverage of about 70 to 75 degrees, and through this, it may support the terminal 1620 operating with an omni-beam (non-directional beam) indoors.

In the situation as illustrated in FIG. 16, the base station 1610 may recognize ‘base station beam’, ‘beam for the external antenna of the repeater’, and ‘beam for the internal patch antenna of the repeater’ as one transmission beam (i.e. single virtual Tx beam). Similarly, the base station 1610 may recognize ‘beam for the external antenna 1621 of the repeater’, ‘beam for the internal patch antenna 1623 of the repeater’, and ‘terminal beam’ as one reception beam (i.e. single virtual Rx beam).

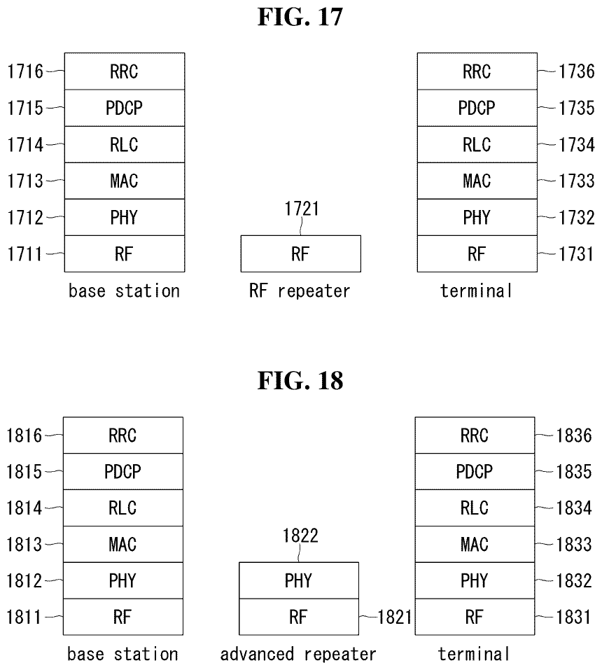

FIG. 17 is a conceptual diagram illustrating a protocol stack for a control plane and a user plane of a wireless communication system including an RF repeater.

A protocol stack of the RF repeater may have the same structure for both a control plane and a user plane. Therefore, the control plane and user plane of the RF repeater may have structures illustrated in FIG. 17.

Referring to FIG. 17, in each of the control plane and user plane for the RF repeater, the base station may include an RF layer 1711, PHY layer 1712, MAC layer 1713, RLC layer 1714, PDCP layer 1715, and RRC layer 1716, and the terminal may also include an RF layer 1731, PHY layer 1732, MAC layer 1733, RLC layer 1734, PDCP layer 1735, and RRC layer 1736. The protocol stacks illustrated in FIG. 17 are the same as the protocol stacks previously described in FIGS. 14A and 14B. Therefore, redundant description will be omitted. However, FIG. 17 is different from FIGS. 14A and 14B in that both the base station and the terminal further includes the RF layers 1711 and 1731. The RF layers 1711 and 1731 may be a general configuration for transmission and reception of RF signals in the wireless communication system such as 3GPP system.

Meanwhile, in FIG. 17, a protocol stack of the repeater, which includes from a PHY layer to an RRC layer, is transparent, and a wireless signal receive by the repeater may be amplified and forwarded from the perspective of an RF 1721 layer.

In the environment illustrated in FIGS. 16 and 17 above, the repeater performs only the simple RF amplification and forwarding function repeatedly, thereby reducing the implementation complexity and cost of the repeater. However, in this situation, since the base station and network cannot explicitly or implicitly manage the repeater, there may be a disadvantage in not being able to explicitly manage the repeater's beams, enhance signal quality, or adjust interference.

The performance of the RF repeater as in FIGS. 16 and 17 may be limited in a time division duplexing (TDD) band (generally, 3.5 GHz band or FR2 band) requiring sophisticated DL/UL switching or in an FR2 band requiring multi-beam operations.

In the 5G NR system, the base station can dynamically indicate a DL/UL direction for each slot and/or symbol to the terminal or IAB node through L1 signaling according to slot format configuration and/or indication. In addition, the base station can dynamically transmit beam/TCI/QCL indication for each channel to the terminal or IAB node. On the other hand, the base station cannot transmit such indication to the RF repeater. Since the RF repeater does not decode a signal transmitted from the base station, even if the base station transmits such indication, the RF repeater is not able to recognize the indication.

To solve the above-described problem, an advanced repeater capable of decoding a part or all of signals transmitted from the base station may be considered.

FIG. 18 is a conceptual diagram illustrating a protocol stack for a control plane of an advanced repeater according to an exemplary embodiment of the present disclosure.

Before referring to FIG. 18, the advanced repeater may be referred to as a smart relay, advanced relay, enhanced relay, low-cost IAB node, and network-control repeater (i.e. NWC repeater or NCR). In addition, the advanced repeater may refer to repeaters with various names that can perform operations described in the present disclosure.

Referring to FIG. 18 only a protocol stack for a control plane for the advanced repeater is illustrated. A protocol stack for a user plane for the advanced repeater may be configured in the same form as previously described in FIG. 17. In other words, as illustrated in FIG. 17, for the user plane of the advanced repeater, the base station may include the RF layer 1711, PHY layer 1712, MAC layer 1713, RLC layer 1714, PDCP layer 1715, and RRC layer 1716, and the terminal also may include the RF layer 1731, PHY layer 1732, MAC layer 1733, RLC layer 1734, PDCP layer 1735, and RRC layer 1736. Additionally, the user plane of the advanced repeater may have only the RF 1721 layer, as illustrated in FIG. 17. Therefore, a protocol stack from the PHY layer to the RRC layer may be transparent in the protocol stack for the user plane of the advanced repeater, and a received wireless signal may be amplified and forwarded from the perspective of the RF layer 1721.

Hereinafter, the control plane for the advanced repeater will be described with reference to FIG. 18. As illustrated in FIG. 18, for the control plane of the advanced repeated, the base station may include an RF layer 1811, PHY layer 1812, MAC layer 1813, RLC layer 1814, PDCP layer 1815, and RRC layer 1816. The terminal may also include an RF layer 1831, PHY layer 1832, MAC layer 1833, RLC layer 1834, PDCP layer 1835, and RRC layer 1836. Therefore, the base station and the terminal may perform signal transmission using the user plane illustrated in FIG. 17 and the control plane illustrated in FIG. 18.

Further, it can be seen that the control plane of the advanced repeater additionally has an RF layer 1821 and a PHY layer 1822, unlike the form illustrated in FIG. 17. Accordingly, the PHY layer 1822 of the advanced repeater may obtain, from the base station, management information such as beam and/or DL/UL configuration and slot format for the repeater, so that control thereon can be performed based on the management information.

The PHY layer 1822 may allow the base station to perform controls on various beams, beam combinations, or slot formats within a link between the base station and the repeater and a link between the repeater and the terminal, by using beam or slot format management/indication information or a capability report of the repeater (or UE capability of the repeater as a UE), to resolve the problems described with reference to FIGS. 15 and 16.

The control plane and user plane protocol stacks of the advanced repeater illustrated in FIG. 18 are for some of the various repeater implementation schemes, and they are not necessarily limited to the form illustrated in FIG. 18. In other words, it is important to note that it is possible to expand the protocol stacks as needed depending on the repeater implementation. For example, if an implementation of the repeater or an operation of the repeater relies on signaling for some higher L2/L3 layers, a part or all of the some higher L2/L3 layers such as the MAC layer may be additionally included in the repeater in addition to the PHY layer 1822 in FIG. 18. The present disclosure does not list all possible forms in order not to obscure the gist of the description.

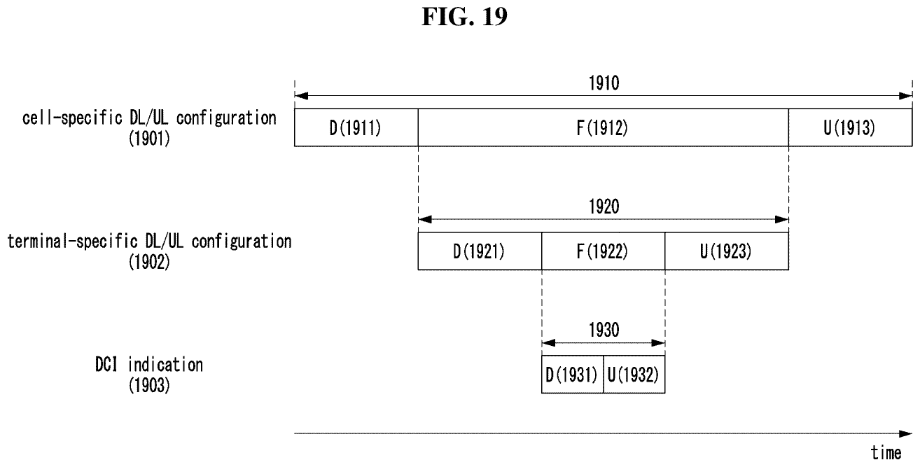

FIG. 19 is a conceptual diagram for describing cell-specific configuration, terminal-specific configuration, and indication information within a specific given time according to TDD configuration.

Referring to FIG. 19, cell-specific DL/UL configuration 1901 may configure cell-specific downlink (D) slot(s)/symbol(s) 1911, cell-specific flexible (F) slot(s)/symbol(s) 1912, and cell-specific uplink (U) slot(s)/symbol(s) 1913, as a format of slots/symbols within a given time period. In this case, the cell-specific DL/UL configuration 1901 may be configured by, for example, a higher layer parameter tdd-UL-DL-ConfigurationCommon.

In FIG. 19, D refers to ‘downlink’, F refers to ‘flexible’, and U refers to ‘uplink’.

In addition, the cell-specific F slot(s)/symbol(s) 1912 may be determined in more detail by a terminal-specific (UE-specific) DL/UL configuration 1902. The UE-specific DL/UL configuration be configured, for example, by a higher layer parameter tdd-UL-DL-ConfigurationDedicated. Referring to FIG. 19, a case, in which the cell-specific F slot(s)/symbol(s) 1912 may be configured to dedicated D slot(s)/symbol(s) 1921, dedicated F slot(s)/symbol(s) 1922, and dedicated U slot(s)/symbol(s), is illustrated.

In this case, slots 1922, which are configured as F slots by both the cell-specific F configuration 1912 and the terminal-specific F configuration 1922, may be indicated by DCI to be dynamic D slots/symbols 1931 or dynamic U slots/symbols 1932. In this case, the DCI may be indicated by, for example, an slot format indication (SFI) value indicated by a DCI format 2_0.

The ‘D/F/U’ and the order of ‘D/F/U’ illustrated in FIG. 19 are merely an example for understanding of the present disclosure, and may be appropriately changed to suit a channel environment or operator's preferences when applied in practice.

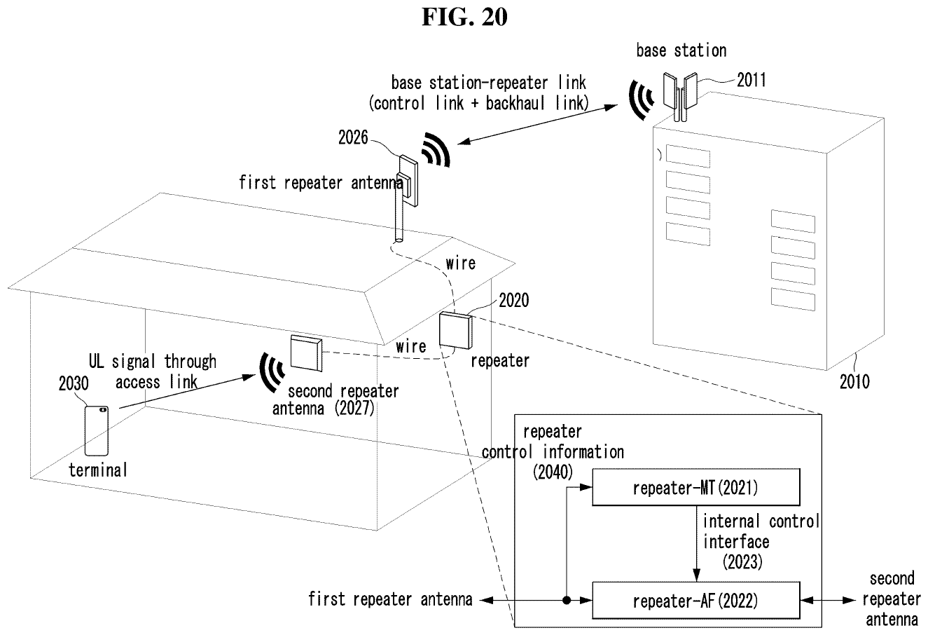

FIG. 20 is a conceptual diagram for describing deployment of a network control repeater.

Referring to FIG. 20, a base station 2010 may transmit and receive RF signals to and from a network-controlled repeater (NCR) through an antenna 2011. In addition, the base station 2010 may transmit and receive RF signals to and from a terminal through the antenna 2011. The antenna 2011 of the base station 2010 may correspond to one or more antennas or antenna groups.

The NCR may include a repeater unit 2020, a first repeater antenna 2026, and a second repeater antenna 2027. The first repeater antenna 2026 and/or the second repeater antenna 2027 of the NCR may correspond to one or more antennas or antenna groups. Therefore, the NCR 2020 may establish a wireless connection between the base station 2010 and the NCR 2020 through the first repeater antenna 2026. Here, the wireless connection may include a control link and/or a backhaul link through RF signals. Further, the NCR 2020 may establish a wireless connection with the terminal 2030 through the second repeater antenna 2027.

The repeater unit 2020 may be composed of a repeater-mobile terminal (MT) 2021 and a repeater-amplify and forward (AF) 2022. The repeater 2020 may have additional components in addition to the repeater-MT 2021 and the repeater-AF 2022, but all of them will not be described in the present disclosure. The repeater-MT 2021 and the repeater-AF 2022 may be connected through an internal control interface 2023.

Based on the configuration described above, a link between the base station and the MCR may be configured as a control link through which signals for the base station 2010 to control the NCR are transmitted, and a backhaul link through which signals for the base station 2010 to provide services to the terminal 2030 are transmitted. A wireless link between the NCR and the terminal 2030 may be collectively referred to as an access link. The repeater unit of the NCR is responsible for signal processing and is composed of the repeater-MT 2021, which receives control signals from the base station 2010 and processes them, and the repeater-AF 2022, which amplifies signals received from the base station 2010, and retransmits the amplified signals. The above-described configuration of the NCR is an example of a possible NCR configuration, and the NCR may include additional components or functions when actually implemented, and the NCR may be referred to as one of the various names described above or referred to as a name other than the various names described above.

The repeater-MT 2021 and the repeater-AF 2022 may be connected to the wireless link with the base station 2010 through the first repeater antenna 2026 of the NCR. In this case, the repeater-MT 2021 may receive repeater control information 2040 through the first repeater first antenna 2026, and indicate repeater control or operation procedures corresponding thereto to the repeater-AF 2022 through the internal control interface 2023. According to the indicated repeater control or operation procedures, the repeater-AF 2022 may amplify signals of the base station 2010, which are received through the first repeater antenna 2026, and transmit the amplified signals to the terminal 2030 through the second repeater antenna 2027 (i.e. downlink relaying). Alternatively, the repeater-AF 2022 may amplify signals of the terminal 2030, which are received through the second repeater antenna 2027, and transmit the amplified signals to the base station 2010 through the first repeater antenna 2026 (i.e. uplink relaying).

The various repeater implementation/configuration schemes of FIGS. 16 to 18 described above may be classified as follows depending on a method or level at which the repeater receives, measures, or interprets signal of the base station.
Repeater type 1: The first type of repeater may be defined as a repeater that does not have a signal processing unit to decode or re-encode signals of the base station. In this case, the repeater may determine a DL/UL direction or beam direction based on characteristics of a wireless signal received from the base station or terminal. To this end, the repeater may need to perform monitoring to determine the characteristics of the wireless signals received from the base station or terminal in a certain time/frequency resource. Here, the characteristics of the wireless signals received from the base station or terminal may include a reception strength, reception time period, degree of change in reception strength (i.e. envelop detection), and/or the like. In addition, the DL/UL direction may refer to a slot format, and the beam direction may mean a TCI to QCL.
Repeater type 2: The second type of repeater may be defined as a repeater that has a signal processing unit capable of receiving cell-specific system information broadcasted from the base station. For example, the broadcast cell-specific system information may refer to DL/UL pattern information preconfigured when installing the repeater, or DL/UL pattern information configured through an application layer. As another example, the broadcast cell-specific system information may be slot format information (i.e. D/F/U information) configured by the higher layer parameter tdd-UL-DL-ConfigurationCommon. In this case, the corresponding type of repeater may be assumed to use only information corresponding to tdd-UL-DL-ConfigurationCommon among the configuration information for slot format indication described above, and may be assumed to be unable to use the configuration information tdd-UL-DL-ConfigurationDedicated indicating the terminal-specific slot formats. In addition, in this case, the repeater may be able to only identify static or semi-static DL/UL directions, and may not be able to determine a DL/UL direction for a resource configured as ‘F’ by tdd-UL-DL-ConfigurationCommon. Here, the resource configured as ‘flexible’ may refer to a resource for which a DU/UL direction can be configured UE-specifically by tdd-UL-DL-ConfigurationDedicated, or can be dynamically indicated by L1 signaling such as DCI format 2_0.
Repeater type 3: The third type of repeater may be defined as a repeater that has a signal processing unit capable of receiving all control information transmitted by the base station. That is, the third type of repeater may refer to a repeater capable of recognizing the above-described slot format indication procedure and applications thereof by using not only the cell-specific configuration information tdd-UL-DL-ConfigurationCommon but also the UE-specific configuration information tdd-UL-DL-ConfigurationDedicated and L1 signaling (e.g. DCI format 2_0 or other DCI format(s) including a slot format indicator (SFI)).

The repeater may have various internal structures depending on the number and configuration of an amplification unit including one or more power amplifier(s) (PA(s)), RF amplifier(s) and/or amplifier group(s).

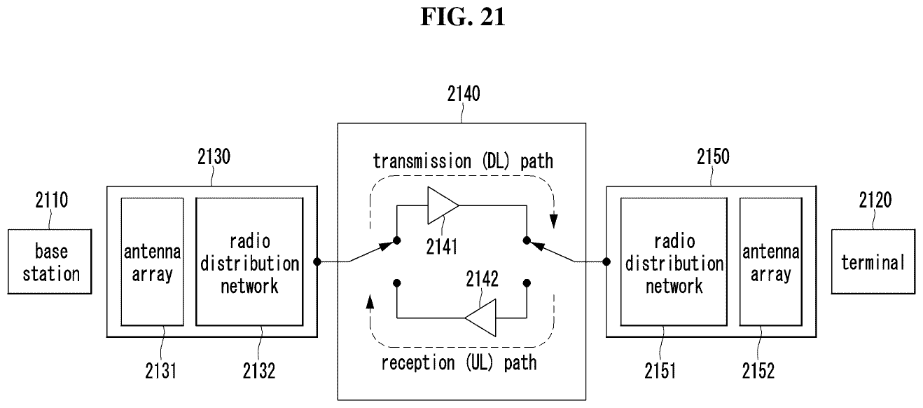

FIG. 21 is a conceptual diagram for describing an amplifier structure and an RF chain configuration according thereto in the NCR.

Referring to FIG. 21, a configuration of a repeater that amplifies signals transmitted/received between a base station 2110 and a terminal 2120 is illustrated. The repeater may include a first antenna 2130, a second antenna 2150, and an RF chain 2140. The first antenna 2130 and the second antenna 2150 may have the same configuration and may be composite antennas. The first antenna 2130 may include an antenna array 2131 and a radio distribution network (RDN) 2132 for receiving signals from or transmitting signals to the base station 2110, and the second antenna 2150 may include an antenna array 2151 and an RDN 2152 for receiving signals from the terminal 2120 or transmitting signals to the terminal 2120. Each of the RDNs 2132 and 2152 included in the first antenna 2130 and the second antenna 2150 may perform an operation of distributing signals to be transmitted or received to the RF chain 2140.

The RF chain 2140 may include a first amplifier 2141 that amplifies signals of a transmission (DL) path and a second amplifier 2142 that amplifies signals of a reception (UL) path. In other words, the RF chain 2140 may include the separate amplifiers 2141 and 2142 for the respective paths. The repeater may connect repeater antenna groups with the transmission path and/or the reception path according to an uplink/downlink direction determined (indicated or detected) at a certain time point.

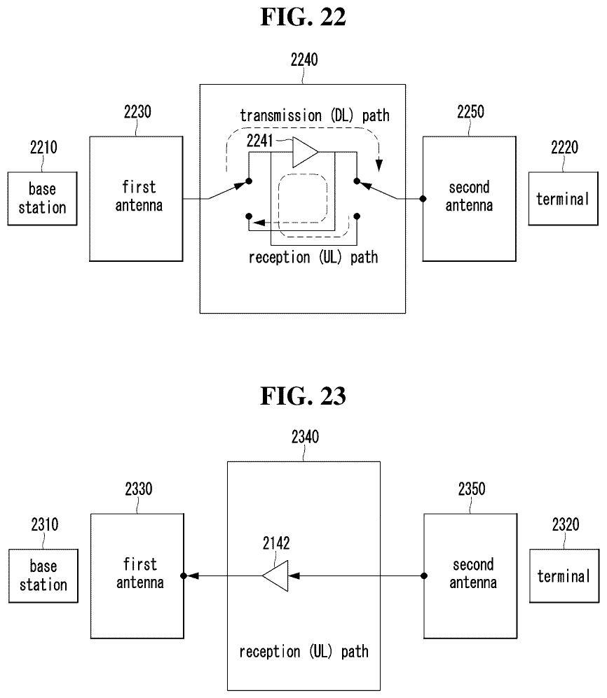

FIG. 22 is a conceptual diagram for describing an amplifier structure and another RF chain configuration according thereto in the NCR.

Referring to FIG. 22, a configuration of a repeater that amplifies signals transmitted/received between a base station 2210 and a terminal 2220 is illustrated. The repeater may include a first antenna 2230, a second antenna 2250, and an RF chain 2240. The first antenna 2230 and the second antenna 2250 may have the same configuration as previously described in FIG. 21. Therefore, redundant description on the configuration of the first antenna 2230 and the second antenna 2250 will be omitted.

Comparing FIGS. 21 and 22, there is a difference in the RF chain 2240. It can be seen that the RF chain 2240 illustrated in FIG. 22 uses one common amplifier. In case of a transmission (DL) path, signals received through the first antenna 2230 may be amplified by an amplifier 2241, and output through the second antenna 2250, as described with reference to FIG. 21. On the other hand, in case of a reception (UL) path, signals received through the second antenna 2250 may be input to the same amplifier 2241 used in the transmission path, and the signals amplified by the amplifier 2241 may be transmitted through the first antenna 2230. Therefore, the repeater may control the repeater antenna groups to be connected with the transmission path or the reception path, depending on an uplink/downlink direction determined (indicated or detected) at a certain time point.

FIG. 23 is a conceptual diagram for describing an amplifier structure and yet another RF chain configuration according thereto in the NCR.

Referring to FIG. 23, a configuration of a repeater that amplifies signals transmitted/received between a base station 2310 and a terminal 2320 is illustrated. The repeater may include a first antenna 2330, a second antenna 2350, and an RF chain 2340. The first antenna 2330 and the second antenna 2350 may have the same configuration as previously described in FIG. 21. Therefore, redundant description on the configuration of the first antenna 2330 and the second antenna 2350 will be omitted.

Comparing FIGS. 21 and 23, there is a difference in the RF chain 2240. It can be seen that the RF chain 2340 illustrated in FIG. 23 uses one amplifier. It can be seen that the repeater illustrated in FIG. 23 has an amplifier only for a reception (UL) path, and there is no transmission (DL) path. Considering that in many cases, bottlenecks in wireless links arise from uplink coverage limitations due to a limited terminal transmit power, this may be a structure to reduce repeater implementation and installation costs and suppress downlink interference caused by the repeater.

The repeater types described above are examples to aid understanding, and can be expanded or modified appropriately when applied in practice.

As an example, the repeater type 2 may be further subdivided into additional subtypes. For instance, a specific repeater may be restricted to receiving only PBCH, thereby receiving only MIB. Alternatively, it may also be capable of receiving some or all of the SIBs, or even a portion of RRC configurations in addition. Various applications may exist in this context. Here, the term ‘part of RRC configurations’ may refer, for example, to cell-specific RRC configurations.

In addition, the repeater may not be restricted to the configuration schemes depicted in FIGS. 21 to 23, but may be configured in various other schemes as well. For example, it may be configured with multiple amplifier pairs in the downlink (DL) path and/or uplink (UL) path, utilizing one or a combination of the configuration schemes.

According to those of FIGS. 21 to 23 and similar configuration schemes, the NCR may need to transmit two different uplink signals. For example, the different uplink signals may include an uplink signal of the repeater-MT and/or a signal obtained by amplifying an uplink signal of the terminal received through an antenna group #2. In this case, a transmit power of each uplink signal may be determined according to Equation 5 below based on 5G NR.

$$P ( i , l ) = min \{ \begin{matrix}{P}_{CMAX} ( i ) \\ {P}_{0} ( i ) + 10 log ( {2}^{μ} \times {M}_{RB} ) + α ( i ) \times PL + Δ ( i ) + f ( i , l )\end{matrix} \qquad [ Equation 5 ]$$

In Equation 5, i may denote a transmission occasion, l may denote a closed loop power control adjustment state, P_{CMAX}(i) may denote the maximum transmit power of the terminal, P₀(i) may denote a nominal UE transmit power, 2^{μ} may denote a subcarrier spacing, M_{RB} may denote the number of RBs allocated to uplink transmission, α(i) may denote a fractional power control coefficient, PL may denote a measured pathloss, Δ(i) may denote an offset according to a modulation and coding scheme, and f(i,l) may denote a closed loop power control value.

In Equation 5, the types and definitions of components may change somewhat depending on a type of channel and/or signal transmitted at a time of transmission, but detailed information is omitted in order not to obscure the gist of description. Here, the type of channel and/or signal may be, for example, PUSCH, PUCCH, SRS, PRACH, etc. For example, P_{CMAX}(i) may be expressed as P_{CMAX,f,c} which is a maximum power that can be used in a carrier f of a serving cell c.

Equation 5 shows that if a value of an instantaneous transmit power determined at a certain transmission time is higher than the value of the maximum transmit power, the transmit power at that transmission time may be set to the maximum transmit power value. Here, the value of the instantaneous transmit power may be determined depending on the terminal implementation and/or separate base station configuration.

The different uplink signals transmitted by the repeater, for example, ‘signal #1: uplink signal of the repeater-MT transmitted through the control link’ and/or ‘signal #2: a signal obtained by amplifying the terminal's uplink signal received at the antenna group #2, which is transmitted through the backhaul link’ may be transmitted according to multiplexing cases as follows.
Time division multiplexing (TDM) mode: a case where the signal #1 and the signal #2 are transmitted using different time resources.
Frequency division multiplexing (FDM) mode: a case where the signal #1 and the signal #2 are transmitted using the same or partially overlapping time resources, but different frequency resources.
Spatial division multiplexing (SDM) mode: a case where the signal #1 and the signal #2 are transmitted using the same or partially overlapping time and frequency resources, but different spatial resources, such as beam and/or antenna domain resources.

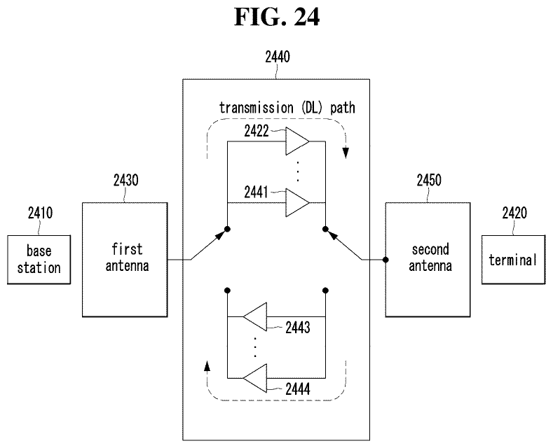

FIG. 24 is a conceptual diagram for describing an amplifier structure and yet another RF chain configuration according thereto in the NCR.

Referring to FIG. 24, a configuration of a repeater that amplifies signals transmitted/received between a base station 2410 and a terminal 2420 is illustrated. The repeater may include a first antenna 2430, a second antenna 2450, and an RF chain 2440. The first antenna 2430 and the second antenna 2450 may have the same configuration as previously described in FIG. 21. Therefore, redundant description on the configuration of the first antenna 2430 and the second antenna 2450 will be omitted.

The RF chain 2440 illustrated in FIG. 24 may include N amplifiers 2441, . . . , and 2442 in a transmission (DL) path, and M amplifiers 2443, . . . , and 2444 in a reception (UL) path. Here, N and M are natural numbers, and N and M may be different values or the same value. When there are the plurality of power amplifiers (PAs) 2441, 2442, 2443, and 2444 in the transmission path and the reception path, the repeater may support carrier aggregation (CA) and/or dual connectivity (DC) in different frequency bands, support multi-TRP functions, and/or support various types of radio links among the base station, terminal, and repeater, such as backhaul link, control link, access link, etc.

FIG. 24 exemplifies the case where some of the plurality of PAs 2441, . . . , and 2444 are used exclusively for downlink (i.e. from the base station to the terminal), others are used exclusively for uplink (i.e. from the terminal to the base station). However, as previously described with reference to FIG. 22, some specific PAs may be configured to be used for uplink/downlink use.

The different frequency bands supported by the respective PAs 2443 and 2444 used for uplink transmission may mean different frequency ranges, different cell groups (CGs), or different uplink cells (i.e. cells, uplink cells, uplink component carriers, UL CCs, CCs). The different TRPs supported by the respective PAs 2443 and 2444 used for uplink transmission may mean different reception (transmission) points, or uplink channels/signals associated with different spatial relations, uplink TCIs, or joint TCIs. Here, the uplink channel and/or signal may be, for example, PUCCH, PUSCH, SRS, RACH, etc.

The different backhaul links and control links supported by the respective PAs 2443 and 2444 used for uplink transmission may mean uplink channels/signals (e.g. PUCCH, PUSCH, SRS, RACH, etc.) or channels/signals transmitted to the base station through a passband of the repeater's backhaul link. The repeater may select at least one transmission path (TX path) or at least one reception path (RX path) to be connected to the repeater antenna according to one of the following exemplary embodiments of the present disclosure.

As an example, a specific repeater may include a first PA for uplink transmission in a first uplink cell of a first cell group and a second PA for uplink transmission in a second uplink cell of a second cell group.

As another example, in a specific repeater, a PA for uplink transmission in a first uplink cell of a first cell group and a PA for uplink transmission in a second uplink cell of a second cell group may be the same PA. In other words, one uplink PA may be used, or the same uplink PA may be shared for multiple uplink cells.

As another example, a specific repeater may include a first PA for uplink transmission in a first uplink cell of a control link and a second PA for uplink transmission in a second uplink cell (or passband) of a backhaul link.

As another example, in a certain repeater, a PA for uplink transmission in a first uplink cell of a control link and a PA for uplink transmission in a second uplink cell (or passband) of a backhaul link may be the same PA. In other words, one uplink PA may be used, or the same uplink PA may be shared for the control ink and the backhaul link.

Meanwhile, considering that the maximum value P_{CMAX}(i) of uplink transmit power in Equation 5 described above is determined for each uplink cell, it can be inferred that P_{CMAX}(i) for uplink cells may be determined differently according to a configuration actually applied to the repeater among the various repeater uplink PA configurations described above. For example, the configuration actually applied to the repeater among the various repeater uplink PA configurations may be determined depending on the number of PAs allocated to each uplink cell or the number of uplink cells that each PA needs to support.

In exemplary embodiments described below, methods for controlling and determining an uplink transmit power of the repeater, considering the various repeater uplink PA configurations, will be described with specific examples.

In addition, methods provided in exemplary embodiments described below may be similarly applied when the transmit power of the repeater is controlled by a value other than an absolute value of the transmit power, for example, a relative value such as a value for controlling a repeater gain for received signals.

In addition, the problem that transmit power control, allocation, or distribution for the repeater may become ambiguous depending on the multiplexing modes described above may similarly occur in other operation modes. For example, such operation modes may include a mode according to a DL/UL direction (or DFU configuration/indication), a mode according to a beam direction, or antenna classification, and/or the like. Hereinafter, a detailed description on all possible operation modes will be omitted in order not to obscure the gist of description, but the methods of the following exemplary embodiments may be applied similarly.

In addition, in the following exemplary embodiments, some operations of a repeater-MT will be described for convenience of description, but in actual application, they can be understood as operations of a terminal (UE or UT).

### [First Exemplary Embodiment] Method for Determining Repeater Power Class

The first exemplary embodiment of the present disclosure provides methods for determining a power class of a repeater. The repeater may determine a power class according to one of the methods of the present exemplary embodiment, and based on this, the repeater may determine a maximum transmit power P_{CMAX}(i) that can be used for an uplink cell (e.g. within an uplink CC, separately-defined specific uplink frequency resource (e.g. one uplink passband), or combination thereof). The determined power class may be used to determine an instantaneous transmit power using Equation 5 described above or a similar method.

The terminal may determine or set the uplink maximum transmit power P_{CMAX}(i), and P_{CMAX}(i) may need to be within a range of Equation 6 below.

$${P}_{P o w e r c l a s s} - f ( MPR , AMPR , PMPR ) \leq {P}_{C M A X} ( i ) \leq {EIRP}_{max} \qquad [ Equation 6 ]$$

In Equation 6, P_{Powerclass} may denote the minimum peak effective isotropic radiated power (EIRP) according to a pre-agreed power class of the terminal, as shown in an example of Table 21 below, EIRPₘₐₓ may denote the maximum EIRP according to the power class of the terminal, as shown in the example of Table 21 below, and f(MPR, AMPR, PMPR) may denote a function using the maximum output power reduction (MPR), MPR with additional requirements (AMPR), and power management maximum power reduction (PMPR). f(MPR, AMPR, PMPR) may have various variations. As an example of such variations, Equation 7 below or its modified form may be used.

$$f ( MPR , AMPR , PMPR ) = max ( max ( MPR , AMPR ) , PMPR ) + Tolerance \qquad [ Equation 7 ]$$

In Equations 6 and 7, values of MPR, A-MPR, P-MPR, and tolerance may be defined differently for various environments such as the terminal's power class, frequency band, and transmission bandwidth. The environments will be referred to as communication configuration environments. In other words, different MPR, A-MPR, P-MPR, and tolerance values may be applied depending on the power class declared and/or reported by the terminal (or repeater). In order not to obscure the gist of description on the present disclosure, detailed MPR, A-MPR, P-MPR, and tolerance values are not provided in the present disclosure.

TABLE 21

| | | Minimum | |
|---|---|---|---|
| | | peak EIRP | |
| UE | | (for band | |
| power | | n257, n258, | Maximum |
| class | UE type | n261) | EIRP |
| 1 | Fixed wireless access (FWA) UE | 40 dBm | 55 dBm |
| 2 | Vehicular UE | 29 dBm | 43 dBm |
| 3 | Handheld UE | 22.4 dBm | 43 dBm |
| 4 | High power non-handheld UE | 34 dBm | 43 dBm |
| 5 | FWA UE | 30 dBm | 43 dBm |
| | | (n257) | |
| | | 30.4 dBm | |
| | | (n258) | |
| 6 | High speed train roof-mounted UE | 30 dBm | 43 dBm |
| | | (n257) | |
| | | 30.4 dBm | |
| | | (n258) | |
| 7 | RedCap UE | 16.4 dBm | 43 dBm |

In 5G NR, a Rel-17 RF repeater supports three repeater power classes: wide area (WA), medium range (MR), and local area (LA). An uplink or downlink rated passband output power P_{rated,p,AC} for each power class may be determined according to Table 22 and Table 23 below.

TABLE 22

| DL transmission repeater class | P_{rated,p,AC} |
|---|---|
| Wide area repeater | Note 1 |
| Medium range repeater | ≤38 dBm + X, Note 2 |
| Local area repeater | ≤24 dBm + X, Note 2 |

Note 1:
There is no upper limit for the rated passband output power P_{rated,p,AC} of the Wide Area repeater
Note 2:
X = 10*log (ceil (passband bandwidth/20 MHz))

TABLE 23

| UL transmission repeater class | P_{rated,p,AC} |
|---|---|
| Wide area repeater | Note 1 |
| Local area repeater | ≤24 dBm+ X, Note 2 |

Note 1:
There is no upper limit for the rated passband output power P_{rated,p,AC} of the Wide Area repeater
Note 2:
X = 10*log (ceil (passband bandwidth/20 MHz))

In case of Rel-17 RF repeater in 5G NR, an uplink rated total radiated power (TRP) P_{rated,p,TRP} and rated EIRP P_{rated,p,EIRP} for each power class WA or LA may be determined according to Table 24 below.

TABLE 24

| UL repeater class | P_{rated,p,TRP} | P_{rated,p,EIRP} |
|---|---|---|
| Wide area | (Note 1) | (Note 1) |
| Local area | ≤+ 35 + X dBm, Note 3 | ≤+ 55 + X dBm, Note 2 |

Note 1:
There is no upper limit for P_{rated,p,TRP} or P_{rated,p,EIRP} of the repeater type 2-O UL transmission.
Note 2:
X = [10*log (ceil (passband bandwidth/100 MHz))]

In the present disclosure described below, the examples of Tables 22 to 24 above and their modified forms will be collectively referred to as ‘maximum transmit power limit’ according to technical specifications (or requirements).

A manufacturer of the repeater may report or declare information on the characteristics of the repeater to a network or mobile communication service provider through higher layer signaling or through separate operation, administration and maintenance (OAM) signaling.

As an example, the reported and/or declared information on the characteristics of the repeater may include a rated output power for a specific frequency resource unit. For example, the specific frequency resource unit may be configured as a passband, passband group, band, band group, cell, cell group, CC, CC group, BWP, BWP group, or the like.

As another example, the reported and/or declared information on the characteristics of the repeater may include a rated EIRP or rated TRP for a specific space resource unit. For example, the specific space resource unit may be configured as an antenna, antenna group, antenna panel, antenna panel group, beam, beam group, or the like.

As another example, the reported and/or declared information on the characteristics of the repeater may include a rated EIRP or rated TRP for a specific repeater operation mode. For example, the specific repeater operation mode may be a mode in which the backhaul link and the control link are TDMed, a mode in which the backhaul link and the control link are FDMed, a mode in which the backhaul link and the control link are SDMed, or the like.

The reported and/or declared information on the characteristics of the repeater may also include a combination of the frequency/space resource unit and the repeater operation mode.

For example, the repeater may respectively report and/or declare ‘first rated EIRP and/or rated TRP for the mode in which the backhaul link and the control link are TDMed based on a first repeater beam’, ‘second rated EIRP and/or rated TRP for the mode in which the backhaul link and the control link are FDMed based on the first repeater beam’, ‘third rated EIRP and/or rated TRP for the mode in which the backhaul link and the control link are TDMed based on a second repeater beam’, and ‘fourth rated EIRP and/or rated TRP for the mode in which the backhaul link and the control link are FDMed based on the second repeater beam’.

The second to fourth rated EIRPs and/or rated TRPs for the FDM mode may not be reported/declared directly, and may be calculated from the first to third rated EIRPs and/or rated TRPs for the TDM mode by using a transmit power adjustment/correction value reported/declared by the repeater, configured/indicated by the base station, or pre-agreed therebetween.

In the present disclosure described below, considering various repeater implementation possibilities and repeater deployment environments, provided are methods for determining the above-described repeater power class (including all or part of the repeater power class for the backhaul link and the repeater-MT power class for the backhaul link or control link).
Method 1-1: The repeater may report or declare one or more power classes simultaneously.

As an example, a first power class among the one or more power classes may be applied to the backhaul link, and a second power class among the one or more power classes may be applied to uplink transmission on the control link, which is transmitted by the repeater-MT.

As another example, when the repeater is declared as a WA class with respect to the backhaul link amplifying and forwarding data signals of the terminal, a first power class may follow the rated TRP and rated EIRP for the WA class defined in Table 24 described above, and when the repeater is declared as a FWA UE supporting a high transmit power with respect to the control link delivering control information for the repeater, a second power class may follow the minimum peak EIRP and maximum EIRP according to the first row of Table 21 above.

As another example, when the repeater is declared as a LA class with respect to the backhaul link amplifying and forwarding data signals of the terminal, a first power class may follow the rated TRP and rated EIRP for the LA class defined in Table 24 described above, and when the repeater is declared as a handheld or RedCap UE supporting a low transmit power with respect to the control link delivering control information for the repeater, a second power class may follow the minimum peak EIRP and maximum EIRP according to the third or seventh row of Table 21 above.

As another example, the repeater may report or declare a power class for each operation mode of the repeater.

For example, when the repeater is declared as a FWA UE supporting a high transmit power assuming that the backhaul link and the control link are TDMed, a first power class may follow the minimum peak EIRP and maximum EIRP according to the first row of Table 21 above, and when the repeater is declared as a handheld or RedCap UE supporting a low transmit power assuming that the backhaul link and the control link are TDMed, a second power class may follow the minimum peak EIRP and maximum EIRP according to the third or seventh row of Table 21 above. In this case, the MPR, A-MPR, and P-MPR values may also be changed depending on whether the backhaul link and control link are TDMed, FDMed, or SDMed, which has an advantage of further increasing the efficiency of transmit power control for each repeater operation mode.
Method 1-2: The repeater may report and/or declare one power class, and additionally report a power control adjustment/correction value for the power class. The power adjustment/correction value may be promised to be applied only to a specific repeater operation mode (e.g. when the backhaul link and the control link are FDMed or SDMed), and promised not to be applied for other operation modes (e.g. when the backhaul link and the control link are TDMed). Alternatively, whether to apply the power adjustment/correction value may be configured through a higher layer parameter or may be indicated through physical layer signaling.

For example, the repeater-MT may report and/or declare a repeater-MT power class 1 (i.e. FWA UE), and report and/or declare a power adjustment/correction value for the FDM case of the backhaul link and control link as X (e.g. −3 dB). In this case, when the repeater operates in a specific operation mode, the base station and repeater may determine actual minimum peak EIRP and maximum EIRP by adding the power adjustment/correction value (e.g. −3 dB) to the minimum peak EIRP and maximum EIRP in the first row of Table 21 above. Here, operating in the specific mode may be, for example, a case where the backhaul link and the control link are FDMed and uplink transmissions occur simultaneously. In the above description, the power adjustment/correction value is assumed to be a single value, but this is for convenience of description. In actual application, one or more adjustment/correction values may be reported/declared depending on types of values to be adjusted. Here the adjustment/correction values may be determined, for example, as an adjustment/correction value X1 for the minimum peak EIRP and an adjustment/correction value X2 for the maximum EIRP.

In the above-described example, in addition to the power adjustment/correction value reported/declared by the terminal (repeater-MT), there may be a separate adjustment/correction value configured/indicated by the base station based thereon. In this case, the terminal (repeater-MT) may apply the adjustment/correction value configured/indicated by the base station when adjusting/correcting the power for the specific repeater operation mode. In other words, the power adjustment/correction value reported/declared by the terminal may not be applied.
Method 1-3: MPR, A-MPR, P-MPR, tolerance relaxation. The repeater may report or declare one power class and separately report or declare at least one of MPR, A-MPR, P-MPR, and tolerance values for the power class. The MPR, A-MPR, P-MPR, and tolerance values may be applied only to a specific repeater operation mode, and may be promised not to be applied to other operation modes, or may be configured or indicated not to be applied to other operation modes through a higher layer parameter or physical layer signaling. For example, the specific repeater operation mode may be, for example, a case where the backhaul link and the control link are TDMed, FDMed, or SDMed, and the other operation modes may include a case where the backhaul link and the control link are TDMed.

The MPR, A-MPR, P-MPR, and tolerance values may be reported/declared as multiple pairs, for example, for each repeater operation mode, to support various repeater operation modes. Here, the repeater operation modes may be, for example, cases where the backhaul link and control link are TDMed, FDMed, and/or SDMed.

Similarly, if the repeater-MT reports/declares a terminal (repeater-MT) power class 1 (i.e. FWA UE), the base station and repeater may be allowed to apply smaller MPR, A-MPR, P-MPR, and tolerance values compared to the terminal. For example, a case where a distance between the repeater and a user is longer than a distance between a general terminal and the user, and a user absorption rate of the repeater's transmitted radio waves is lower may be considered.
Method 1-4: The repeater may report/declare at least one of a rated output power, rated EIRP, or rated TRP for a specific frequency/space resource unit or specific repeater operation mode to the network or mobile communication service operator through higher layer signaling or separate OAM signaling, and the repeater-MT power class may be determined as a function of some of all of the reported/declared values.

As an example, the repeater may declare a rated EIRP value for a repeater beam A to the network or operator through OAM signaling. Then, the repeater and base station may use the declared rated EIRP value as P_{Powerclass} for the repeater-MT to derive P_{CMAX}(i) of the repeater-MT through Equation 6 above.

As another example, the repeater may declare a rated EIRP value and a transmit power adjustment/correction value for a repeater beam B to the network or operator through OAM signaling. Then, the repeater and base station may use a value which is obtained by adding the transmit power adjustment/correction value to the declared rated EIRP value (or, a value adjusted considering the transmit power adjustment/correction value) as P_{Powerclass} for the repeater-MT to derive P_{CMAX}(i) of the repeater-MT through Equation 6 above

### [Second Exemplary Embodiment] Method for Determining a Transmit Power According to a Repeater PA Structure

The present disclosure described below provides methods for determining the maximum transmit power of the repeater in consideration of various repeater implementation possibilities and repeater deployment environments.

A repeater PA structure may vary according to whether to adopt PA(s) per cell group to support CA and/or DC, whether to adopt PA(s) per link to support backhaul and control links, and whether to adopt PA(s) per beam to support multi-beams simultaneously.

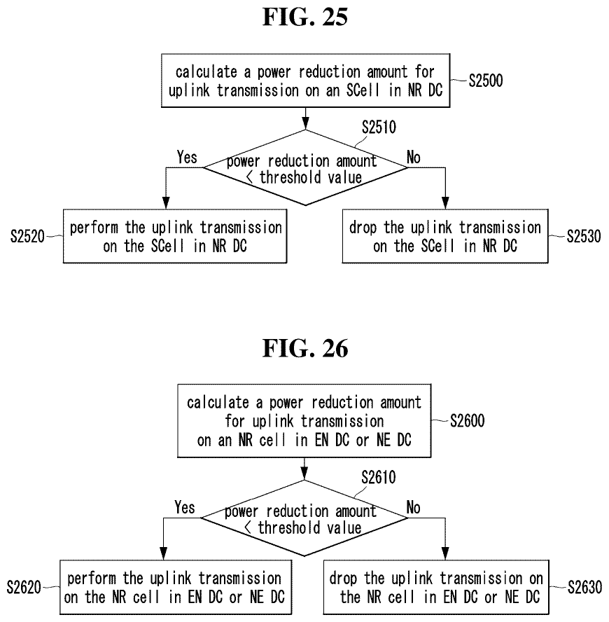

FIG. 25 is a flowchart for describing a case where a repeater needs to adjust an uplink transmit power in a specific cell during NR DC operations according to an exemplary embodiment of the present disclosure.

FIG. 25 shows a case of adjusting an uplink transmit power when the repeater operates in an NR DC scheme. Here, the NR DC scheme may mean that both cell groups operate in the 5G NR scheme. In addition, adjustment of an uplink transmit power in a specific cell may mean that the uplink transmit power in the specific cell needs to be adjusted for reasons such as sharing some PAs between different cell groups. In other words, FIG. 25 may correspond to a case where maximum transmit power limit information including the repeater power class is determined based on the first exemplary embodiment described above, and power adjustment is required thereafter.

Referring to FIG. 25, a repeater-MT operating in the NR DC scheme may calculate a power reduction amount for uplink transmission in an SCell when performing uplink transmissions in two different uplink cells (S2500).

The repeater may compare a threshold value and the power reduction amount calculated in step S2500 (S2510). In this case, the threshold value may be a preset value. For example, the threshold may be a value set through a higher layer parameter xScale. As a result of the comparison in step S2510, if the power reduction amount calculated in step S2500 is less than the threshold value, the repeater may proceed to step S2520. As the result of the comparison in step S2510, if the power reduction amount calculated in step S2500 is not less than the threshold value, in other words, if the power reduction amount calculated in step S2500 is greater than or equal to the threshold value, the repeater may proceed to step S2530.

When proceeding to step S2520, the repeater may determine that the corresponding uplink transmission is valid and may perform the uplink transmission for the SCell by applying the power reduction amount calculated in step S2500.

On the other hand, when proceeding to step S2530, the repeater may determine that the corresponding uplink transmission is invalid due to too much power reduction and may not perform the uplink transmission for the SCell. In other words, the repeater may drop the uplink transmission for the SCell.

FIG. 26 is a flowchart for describing a case where a repeater needs to adjust an uplink transmit power in a specific cell during EN DC or NE DC operations according to an exemplary embodiment of the present disclosure.

FIG. 26 shows a case where the repeater operates in an EN DC or NE DC scheme. In this case, one of two cell groups may operate in the LTE scheme and the other may operate in the 5G NR scheme. In addition, as previously described in FIG. 25, adjustment of an uplink transmit power in a specific cell may mean that the uplink transmit power needs to be adjusted in the specific cell for reasons such as sharing some PAs between different cell groups. In other words, FIG. 26 may correspond to a case where maximum transmit power limit information including the repeater power class is determined based on the first exemplary embodiment described above, and power adjustment is required thereafter.

Referring to FIG. 26, a repeater-MT operating in the EN DC or NE DC scheme may calculate a power reduction amount for uplink transmission in an NR cell when performing uplink transmissions in two different uplink cells (S2600).

The repeater may compare a threshold value and the power reduction amount calculated in step S2600 (S2610). In this case, the threshold value may be a preset value. For example, the threshold may be a value set through a higher layer parameter xScale. As a result of the comparison in step S2610, if the power reduction amount calculated in step S2600 is less than the threshold value, the repeater may proceed to step S2620. As the result of the comparison in step S2610, if the power reduction amount calculated in step S2600 is not less than the threshold value, in other words, if the power reduction amount calculated in step S2600 is greater than or equal to the threshold value, the repeater may proceed to step S2630.

When proceeding to step S2620, the repeater may determine that the corresponding uplink transmission is valid and may perform the uplink transmission for the NR cell by applying the power reduction amount calculated in step S2600.

On the other hand, when proceeding to step S2630, the repeater may determine that the corresponding uplink transmission is invalid due to too much power reduction and may not perform the uplink transmission for the NR cell. In other words, the repeater may drop the uplink transmission for the NR cell.

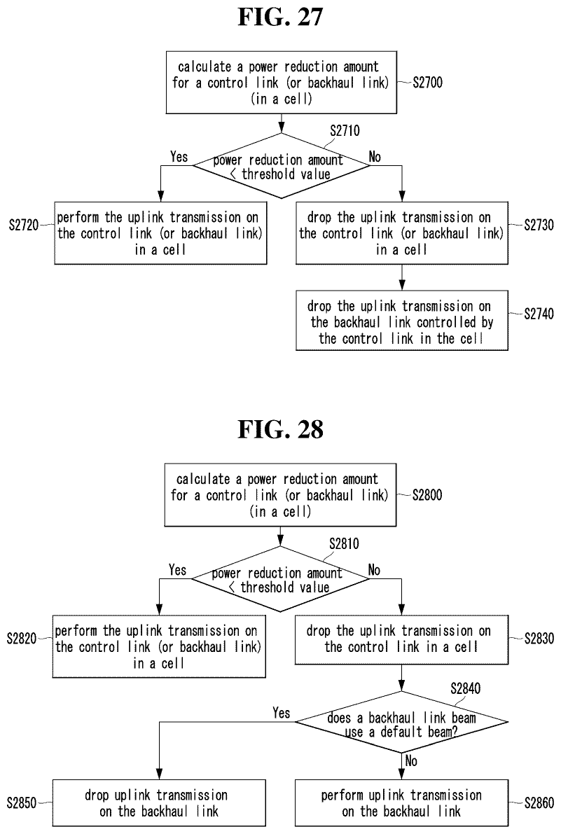

FIG. 27 is a flowchart for describing a case where a repeater needs to adjust a specific uplink transmit power due to sharing some PAs between backhaul link uplink transmission and control link uplink transmission according to an exemplary embodiment of the present disclosure.

FIG. 27 shows a case where the repeater needs to adjust a transmit power of some PAs due to sharing between backhaul link uplink transmission and control link uplink transmission. As described above, the repeater may need to perform power reduction on an uplink of the control link (or backhaul link) for various reasons. Operations of the repeater will be described with reference to FIG. 27. In other words, FIG. 27 may also correspond to a case where maximum transmit power limit information including the repeater power class is determined based on the first exemplary embodiment described above, and power adjustment is required thereafter.

Referring to FIG. 27, the repeater may calculate a power reduction amount for the uplink transmission of the control link (or backhaul link) (S2700). In step S2700, the power reduction for the control link (or backhaul link) uplink transmission may be due to CA or DC operation as shown in the examples of FIGS. 25 and/or 26, or due to two different uplink transmissions according to FDM and/or SDM operations for backhaul link uplink transmission and control link uplink transmission.

If a reason for the power reduction is FDM and/or SDM operation for the backhaul link uplink transmission and the control link uplink transmission, the power reduction amount for the control link uplink transmission may be a difference between A1 and B1. Here, A1 may be a value of the maximum available transmit power when the control link uplink transmission is performed alone, that is, when the backhaul link and control link are TDMed. B1 may be a value of the maximum (or instantaneous) available transmit power of the control link when performing FDM and/or SDM operation for the backhaul link uplink transmission and the control link uplink transmission.

If a reason for the power reduction is FDM and/or SDM operation for the backhaul link uplink transmission and the control link uplink transmission, the power reduction amount for the backhaul link uplink transmission may be a difference between A2 and B2. Here, A2 may be a value of the maximum available transmit power when the backhaul link uplink transmission is performed alone, that is, when the backhaul link and control link are TDMed. B2 may be a value of the maximum (or instantaneous) available transmit power of the backhaul link when performing FDM and/or SDM operation for the backhaul link uplink transmission and the control link uplink transmission.

If a reason for the power reduction is CA/DC operation, the power reduction amount may be calculated in the same manner as previously described in FIGS. 25 and 26.

When proceeding to step S2720, that is, if the required power reduction amount calculated in step S2700 is less than a threshold value, the repeater may determine that the corresponding uplink transmission is valid. Accordingly, the repeater may perform the control link (or backhaul link) uplink transmission by applying the power reduction amount (S2720).

On the other hand, when proceeding to step S2730, that is, if the required power reduction amount calculated in step S2700 is equal to or greater than the threshold value, the repeater may determine that the corresponding uplink transmission is invalid due to too much power reduction and may not perform the corresponding control link (or backhaul link) uplink transmission. In other words, the repeater may drop the corresponding control link (or backhaul link) uplink transmission.

The repeater may determine that uplink transmission (or downlink reception) for the backhaul link controlled by the control link for which uplink transmission was dropped in step S2730 is also invalid, and may also drop the uplink transmission (or downlink reception) for the backhaul link.

Through this, the repeater may simultaneously secure the control link and backhaul link transmission efficiency/performance in the cell in which power reduction is not performed among the cell in which power reduction is performed and the cell in which power reduction is not performed.

FIG. 28 is a flowchart for describing a case where a repeater needs to adjust a specific uplink transmit power when sharing some PAs between backhaul link uplink transmission and control link uplink transmission according to an exemplary embodiment of the present disclosure.

Similarly to FIG. 27, FIG. 28 shows a case where a repeater needs to adjust a transmit power of some PAs due to sharing between backhaul link uplink transmission and control link uplink transmission. As described, the repeater may need to perform power reduction on the uplink of the control link (or backhaul link) for various reasons. Operations of the repeater will be described with reference to FIG. 28. In other words, FIG. 28 may also correspond to a case where maximum transmit power limit information including the repeater power class is determined based on the first exemplary embodiment described above, and power adjustment is required thereafter.

Referring to FIG. 28, the repeater may calculate a power reduction amount for the uplink transmission of the control link (or backhaul link) (S2800). The power reduction for the control link (or backhaul link) uplink transmission in step S2800 may be due to CA or DC operation as shown in the examples of FIGS. 25 and/or 26, or may be due to two different uplink transmissions according to FDM and/or SDM operations for backhaul link uplink transmission and control link uplink transmission.

If a reason for the power reduction is FDM and/or SDM operation for the backhaul link uplink transmission and the control link uplink transmission, the power reduction amount for the control link uplink transmission may be a difference between A3 and B3. Here, A3 may be a value of the maximum available transmit power when the control link uplink transmission is performed alone, that is, when the backhaul link and control link are TDMed. B3 may be a value of the maximum (or instantaneous) available transmit power of the uplink of the control link when performing FDM and/or SDM operation for the backhaul link uplink transmission and the control link uplink transmission.

If a reason for the power reduction is FDM and/or SDM operation for the backhaul link uplink transmission and the control link uplink transmission, the power reduction amount for the backhaul link uplink transmission may be a difference between A4 and B4. Here, A4 may be a value of the maximum available transmit power when the backhaul link uplink transmission is performed alone, that is, when the backhaul link and control link are TDMed. B4 may be a value of the maximum (or instantaneous) available transmit power of the uplink of the backhaul link when performing FDM and/or SDM operation for the backhaul link uplink transmission and the control link uplink transmission.

If a reason for the power reduction is CA/DC operation, the power reduction amount may be calculated in the same manner as previously described in FIGS. 25 and 26.

When proceeding to step S2820, that is, if the required power reduction amount calculated in step S2800 is less than a threshold value, the repeater may determine that the corresponding uplink transmission is valid. Accordingly, the repeater may perform the control link (or backhaul link) uplink transmission by applying the power reduction amount (S2820).

On the other hand, when proceeding to step S2830, that is, if the required power reduction amount calculated in step S2800 is equal to or greater than the threshold value, the repeater may determine that the corresponding uplink transmission is invalid due to too much power reduction and may not perform the corresponding control link (or backhaul link) uplink transmission. In other words, the repeater may drop the corresponding control link (or backhaul link) uplink transmission.

Then, the repeater may check whether a backhaul link beam controlled by the unperformed (dropped) transmission on the control link is a default beam. As a result of checking in step S2840, if the backhaul link controlled by the control link uses the default beam for uplink transmission, the repeater may proceed to step S2850. On the other hand, as the result of checking in step S2840, if the backhaul link controlled by the control link does not use the default beam for uplink transmission, the repeater may proceed to step S2860.

When proceeding to step S2850, that is, if the default beam is used for uplink transmission of the backhaul link, the default beam may be a beam associated with a PUCCH resource referenced by the lowest PUCCH resource identifier (PRI) within the control link for which transmission is dropped. Here, the beam associated with the PUCCH resource referenced by the lowest PRI may be indicated by one of PUCCH spatial relation information, UL TCI, or joint TCI. If transmission of the default beam is dropped as described above, definition of the default beam may become ambiguous from the base station's perspective. Therefore, in this case, the repeater may drop uplink transmission on the backhaul link following the dropped PUCCH beam.

In other words, if the backhaul link does not use the default beam, the repeater's beam for backhaul link uplink transmission follows separately indicated beam information, so the definition of the backhaul link uplink beam does not become ambiguous from the base station's perspective. Therefore, in step S2860, the repeater may perform uplink transmission on the backhaul link.

In FIGS. 26 to 28 described above, it has been described that ‘xScale’ is used as a single higher layer parameter in all cases. However, this is for convenience of description, and in actual application, separate independent parameters may be defined for the respective cases, such as ‘xScale’, ‘xScale2’, and ‘xScale3’, to determine whether or not to apply the power reduction method for each situation.

When actually implementing a repeater, the above-described exemplary embodiments do not need to be mutually exclusive, and a combinations of various exemplary embodiments may be considered. For example, the repeater may determine the repeater power class using Method 1-1 of the first exemplary embodiment and simultaneously perform transmit power reduction based on the second exemplary embodiment. In addition, the repeater may report to the base station information on which of the functions of the exemplary embodiments have been implemented or have not been implemented. Based on this, the base station may indicate which operation the repeater is to perform through L1 signaling or higher layer signaling. Various other applications are possible, but they are omitted in order not to obscure the gist of the explanation.

Meanwhile, it should be noted that the operations of the repeater, which are described above in FIGS. 26 to 28, may be understood as operations in a terminal as described above.

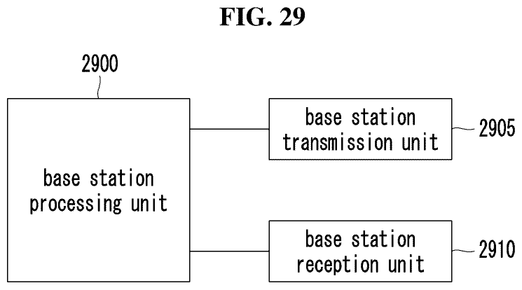

FIG. 29 is a block diagram illustrating a base station according to an exemplary embodiment of the present disclosure.

Referring to FIG. 29, a base station may include a base station processing unit 2900, a base station transmission unit 2905, and a base station reception unit 2910. The components of FIG. 29 are shown as an exemplary embodiment, and the base station may further include additional component(s) depending on an exemplary embodiment of the present disclosure or intention of a telecommunication service operator.

For example, although not illustrated in FIG. 29, the base station may further include a memory. In addition, the base station may further include wired/wireless interfaces for connection to external devices. In addition, the base station may further include an interface to allow the operator to identify operations of the base station. In addition to the form described above, the base station may include additional component(s) depending on a need of a telecommunication service operator or producer.

The base station processing unit 2900 may perform determination and processing for overall operations of the base station according to the exemplary embodiments of the present disclosure described above. For example, the base station processing unit 2900 may determine an operation mode or control transmission of information related to the determined operation mode to the terminal through higher layer signaling or physical layer signaling. Additionally, if the base station processing unit 2900 has an additional memory, the base station processing unit 2900 may control the information to be stored in the memory. The base station processing unit 2900 may control a reception operation of the base station reception unit 2910 as well as a transmission operation of the base station transmission unit 2905. In particular, the base station processing unit 2900 may determine which method to use among the method of the first and second exemplary embodiments described in the present disclosure, and indicate the determined method to the repeater.

The base station transmission unit 2905 may transmit data received from the base station processing unit 2900 in downlink under control by the base station processing unit 2900. The base station reception unit 2910 may receive an uplink channel/signal under control by the base station processing unit 2900 and provide it to the base station processing unit 2900.

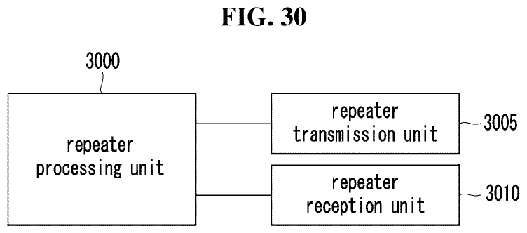

FIG. 30 is a block diagram illustrating a repeater according to an exemplary embodiment of the present disclosure.

Referring to FIG. 30, a repeater may include a repeater processing unit 3000, a repeater transmission unit 3005, and a repeater reception unit 3010. The components of FIG. 30 are shown as an exemplary embodiment, and the repeater may further include additional component(s) according to an exemplary embodiment of the present disclosure or an intention of a telecommunication service operator.

For example, although not illustrated in FIG. 30, the repeater may further include a memory. In addition, the repeater may further include wired/wireless interfaces for connection to external devices.

The repeater processing unit 300 may perform determination and processing for overall operations of the repeater according to the exemplary embodiments of the present disclosure described above. For example, the repeater processing unit 3000 may determine and process the overall operations of the repeater according to the exemplary embodiments of the present disclosure, store various information and procedures therefor, or control the repeater reception unit 3005 and the repeater reception unit 3010 to transmit/receive signals appropriately. Additionally, if the repeater processing unit 3000 further includes a memory, the repeater processing unit 3000 may control information to be stored in the memory.

The repeater transmission unit 3005 may transmit data received from the repeater processing unit 3000 in uplink under control by the repeater processing unit 3000. The repeater reception unit 3010 may receive a downlink channel/signal under control by the repeater processing unit 3000 and provide it to the repeater processing unit 3000.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a wireless repeater, comprising:
determining at least one repeater power class of the wireless repeater, based on a communication configuration environment between the wireless repeater and a base station;
reporting repeater power class information corresponding to the determined at least one repeater power class to the base station;
receiving uplink transmit power parameters from the base station through higher layer signaling;
determining an uplink transmit power for the base station based on the repeater power class information and the uplink transmit power parameters; and
performing uplink transmission using the determined uplink transmit power.

2. The method according to claim 1, wherein the communication configuration environment is determined based on at least one of the at least one repeater power class of the wireless repeater, a frequency band used by the wireless repeater, or a transmission bandwidth of the wireless repeater.

3. The method according to claim 1, wherein the at least one repeater power class includes at least one of a first power class applied to a backhaul link or a second power class applied to uplink transmission of a control link.

4. The method according to claim 3, wherein the first power class and the second power class are simultaneously reported to the base station.

5. The method according to claim 3, further comprising:
reporting at least one of the first power class or the second power class to the base station; and
reporting an unreported remaining one of the first power class or the second power class to the base station.

6. The method according to claim 1, further comprising:
calculating a power reduction value based on a transmit power change situation when a change condition of the uplink transmit power is satisfied; and
in response to the power reduction value smaller than a threshold value based on the uplink transmit power parameters, updating the uplink transmit power using the power reduction value.

7. The method according to claim 6, further comprising: in response to the power reduction value equal to or greater than a threshold value based on the uplink transmit power parameters, dropping the uplink transmission.

8. The method according to claim 6, wherein the change condition includes at least one of a case when the wireless repeater performs uplink transmissions for different uplink cells based on dual connectivity (DC), a case when the wireless repeater performs different uplink transmissions based on carrier aggregation (CA) in different frequency bands, a case when uplink transmission of a backhaul link and uplink transmission of a control link are frequency-division-multiplexed (FDMed), or a case when uplink transmission of the backhaul link and uplink transmission of the control link are spatial-division-multiplexed (SDMed).

9. The method according to claim 8, wherein when the change condition is the case when uplink transmission of the backhaul link and uplink transmission of the control link are FDMed, the power reduction value is calculated as a difference between a maximum available transmit power when the uplink transmission of the backhaul link is performed alone and a maximum transmit power when the uplink transmission of the backhaul link and the uplink transmission of the control link are simultaneously performed by frequency-division-multiplexing (FDM).

10. The method according to claim 8, wherein when the change condition is the case when uplink transmission of the backhaul link and uplink transmission of the control link are SDMed, the power reduction value is calculated as a difference between a maximum available transmit power when the uplink transmission of the backhaul link is performed alone and a maximum transmit power when the uplink transmission of the backhaul link and the uplink transmission of the control link are simultaneously performed by spatial-division-multiplexing (SDM).

11. A method of a wireless repeater, comprising:
determining at least one repeater power class of the wireless repeater, based on a communication configuration environment between the wireless repeater and a base station;
reporting repeater power class information corresponding to the determined at least one repeater power class to the base station;
receiving uplink transmit power parameters from the base station through higher layer signaling;
in response to that a change condition of an uplink transmit power of a control link is satisfied, calculating a power reduction value based on a transmit power change situation, the uplink transmit power of the control link being determined based on the uplink transmit power parameters; and
in response to the power reduction value less than a threshold value based on the uplink transmit power parameters, updating the uplink transmit power of the control link using the power reduction value.

12. The method according to claim 11, further comprising: in response to the power reduction value equal to or greater than a threshold value based on the uplink transmit power parameters, dropping uplink transmission on the control link.

13. The method according to claim 11, wherein the change condition includes at least one of a case when the wireless repeater performs uplink transmissions for different uplink cells based on dual connectivity (DC), a case when the wireless repeater performs different uplink transmissions based on carrier aggregation (CA) in different frequency bands, a case when uplink transmission of a backhaul link and uplink transmission of a control link are frequency-division-multiplexed (FDMed), or a case when uplink transmission of the backhaul link and uplink transmission of the control link are spatial-division-multiplexed (SDMed).

14. The method according to claim 13, wherein when the change condition is the case when uplink transmission of the backhaul link and uplink transmission of the control link are FDMed, the power reduction value is calculated as a difference between a maximum available transmit power when the uplink transmission of the backhaul link is performed alone and a maximum transmit power when the uplink transmission of the backhaul link and the uplink transmission of the control link are simultaneously performed by frequency-division-multiplexing (FDM).

15. The method according to claim 13, wherein when the change condition is the case when uplink transmission of the backhaul link and uplink transmission of the control link are SDMed, the power reduction value is calculated as a difference between a maximum available transmit power when the uplink transmission of the backhaul link is performed alone and a maximum transmit power when the uplink transmission of the backhaul link and the uplink transmission of the control link are simultaneously performed by spatial-division-multiplexing (SDM).

16. A wireless repeater comprising a processor, wherein the processor causes the wireless repeater to perform:
determining at least one repeater power class of the wireless repeater, based on a communication configuration environment between the wireless repeater and a base station;
reporting repeater power class information corresponding to the determined at least one repeater power class to the base station;
receiving uplink transmit power parameters from the base station through higher layer signaling;
determining an uplink transmit power for the base station based on the repeater power class information and the uplink transmit power parameters; and
performing uplink transmission using the determined uplink transmit power.

17. The wireless repeater according to claim 16, wherein the communication configuration environment is determined based on at least one of the at least one repeater power class of the wireless repeater, a frequency band used by the wireless repeater, or a transmission bandwidth of the wireless repeater, and the at least one repeater power class includes at least one of a first power class applied to a backhaul link or a second power class applied to uplink transmission of a control link.

18. The wireless repeater according to claim 17, wherein the processor further causes the wireless repeater to perform:
simultaneously reporting the first power class and the second power class to the base station; or
reporting at least one of the first power class or the second power class to the base station and reporting an unreported remaining one of the first power class or the second power class to the base station.

19. The wireless repeater according to claim 16, wherein the processor further causes the wireless repeater to perform:
calculating a power reduction value based on a transmit power change situation when a change condition of the uplink transmit power is satisfied;
in response to the power reduction value smaller than a threshold value based on the uplink transmit power parameters, updating the uplink transmit power using the power reduction value; and
in response to the power reduction value equal to or greater than a threshold value based on the uplink transmit power parameters, dropping the uplink transmission.

20. The wireless repeater according to claim 19, wherein the change condition includes at least one of a case when the wireless repeater performs uplink transmissions for different uplink cells based on dual connectivity (DC), a case when the wireless repeater performs different uplink transmissions based on carrier aggregation (CA) in different frequency bands, a case when uplink transmission of a backhaul link and uplink transmission of a control link are frequency-division-multiplexed (FDMed), or a case when uplink transmission of the backhaul link and uplink transmission of the control link are spatial-division-multiplexed (SDMed).
